(19) United States
(12) Patent Application Publication
(10) Pub. No.: US 2026/0322571 A1
(43) Pub. Date: Oct. 15, 2026

(54) DEVICES, METHODS, APPARATUSES, AND COMPUTER READABLE MEDIA FOR CARRIER

(71) Applicant: Nokia Technologies Oy, Espoo (FI)

(72) Inventors: Bent Henneberg Rysgaard, Aalborg (DK); Kim Nielsen, Storvorde (DK); Johannes Hejselbaek, Holstebro (DK)

(21) Appl. No.: 19/344,904

(22) Filed: Sep. 30, 2025

(30) Foreign Application Priority Data
Oct. 4, 2024 (FI) 20246201

(51) Int. Cl. H04L 5/00; H04B 7/0413

(52) U.S. Cl. CPC H04L 5/0098; H04B 7/0413; H04L 5/0094

(57) ABSTRACT

Disclosed are devices, methods, apparatuses, and computer readable media for carrier aggregation. An example apparatus for a terminal device may include at least one processor and at least one memory. The at least one memory may store instructions that, when executed by the at least one processor, may cause the apparatus at least to: receive a carrier aggregation configuration including at least one combination of component carriers; and in response to receiving the carrier aggregation configuration, determine an operational state for receiving a configured combination of component carriers from the at least one combination of component carriers, wherein the operational state is used to determine at least one of: a number of activated receiving, RX, antennas or a number of RX chains.

### TECHNICAL FIELD

Various example embodiments relate to devices, methods, apparatuses, and computer readable media for carrier aggregation (CA).

### BACKGROUND

CA may comprise inter-band CA, non-contiguous intra-band carrier aggregation (NC IB CA), etc. NC IB CA may also be referred to as fragmented carriers. Multi-input multi-output (MIMO) reception across multiple antennas can be used for the reception of fragmented carriers. According to requirements for user equipment (UE) receive (RX) antenna, or referred to as antenna port, a minimum of 2 RX antennas must be implemented, and the 2 RX antennas may be realized by a main module and a diversity module. Further, the UE is required to be equipped with a minimum of two Rx antenna ports in operating bands except for the bands n7, n38, n41, n48, n77, n78, n79, n104 where the UE is required to be equipped with a minimum of four RX antenna ports. In, for example, fifth generation of mobile communication system (5G), despite 4 RX antennas are mandated only in some bands, for example n7, UE implementation favors that 4 RX antennas are used for all bands excluding low bass (LB).

### SUMMARY

A brief summary of exemplary embodiments is provided below to provide basic understanding of some aspects of various embodiments. It should be noted that this summary is not intended to identify key features of essential elements or define scopes of the embodiments, and its sole purpose is to introduce some concepts in a simplified form as a preamble for a more detailed description provided below.

In a first aspect, disclosed is an apparatus for a terminal device. The apparatus may comprise at least one processor and at least one memory. The at least one memory may store instructions that, when executed by the at least one processor, may cause the apparatus at least to: transmit, to a network node, capabilities of the apparatus comprising at least one of band combinations supported by the apparatus, fragmented carriers supported by the apparatus, and multiple operational states supported by the apparatus associated with MIMO reception across multiple antennas that enable multiple MIMO layers; and receive, from the network node, a configuration of a transition between the multiple operational states; wherein one operational state of the multiple operational states is used to determine at least one of: a number of activated RX antennas or a number of RX chains.

In a second aspect, disclosed is an apparatus for a network device. The apparatus may comprise at least one processor and at least one memory. The at least one memory may store instructions that, when executed by the at least one processor, may cause the apparatus at least to: receive, from a terminal device, capabilities of the apparatus comprising at least one of band combinations supported by the terminal device, fragmented carriers supported by the terminal device, and multiple operational states supported by the terminal device associated with MIMO reception across multiple antennas that enable multiple MIMO layers; and transmit, to the terminal device, a configuration comprising a transition between the multiple operational states, wherein one operational state of the multiple operational states is used to determine at least one of: a number of activated RX antennas or a number of RX chains.

In a third aspect, disclosed is a method performed by an apparatus for a terminal device. The method may comprise: transmitting, to a network node, capabilities of the apparatus comprising at least one of band combinations supported by the apparatus, fragmented carriers supported by the apparatus, and multiple operational states supported by the apparatus associated with MIMO reception across multiple antennas that enable multiple MIMO layers; and receiving, from the network node, a configuration of a transition between the multiple operational states; wherein one operational state of the multiple operational states is used to determine at least one of: a number of activated RX antennas or a number of RX chains.

In a fourth aspect, disclosed is a method performed by an apparatus for a network device. The method may comprise: receiving, from a terminal device, capabilities of the apparatus comprising at least one of band combinations supported by the terminal device, fragmented carriers supported by the terminal device, and multiple operational states supported by the terminal device associated with MIMO reception across multiple antennas that enable multiple MIMO layers; and transmitting, to the terminal device, a configuration comprising a transition between the multiple operational states, wherein one operational state of the multiple operational states is used to determine at least one of: a number of activated RX antennas or a number of RX chains.

In a fifth aspect, disclosed is an apparatus for a terminal device. The apparatus may comprise: means for transmitting, to a network node, capabilities of the apparatus comprising at least one of band combinations supported by the apparatus, fragmented carriers supported by the apparatus, and multiple operational states supported by the apparatus associated with MIMO reception across multiple antennas that enable multiple MIMO layers; and means for receiving, from the network node, a configuration of a transition between the multiple operational states; wherein one operational state of the multiple operational states is used to determine at least one of: a number of activated RX antennas or a number of RX chains.

In a sixth aspect, disclosed is an apparatus for a network device. The apparatus may comprise: means for receiving, from a terminal device, capabilities of the apparatus comprising at least one of band combinations supported by the terminal device, fragmented carriers supported by the terminal device, and multiple operational states supported by the terminal device associated with MIMO reception across multiple antennas that enable multiple MIMO layers; and means for transmitting, to the terminal device, a configuration comprising a transition between the multiple operational states, wherein one operational state of the multiple operational states is used to determine at least one of: a number of activated RX antennas or a number of RX chains.

In a seventh aspect, a computer-readable medium is disclosed. The computer-readable medium may comprise program instructions that, when executed by an apparatus for a terminal device, may cause the apparatus at least to: transmit, to a network node, capabilities of the apparatus comprising at least one of band combinations supported by the apparatus, fragmented carriers supported by the apparatus, and multiple operational states supported by the apparatus associated with MIMO reception across multiple antennas that enable multiple MIMO layers; and receive, from the network node, a configuration of a transition between the multiple operational states; wherein one operational state of the multiple operational states is used to determine at least one of: a number of activated RX antennas or a number of RX chains.

In an eighth aspect, a computer-readable medium is disclosed. The computer-readable medium may comprise program instructions that, when executed by an apparatus for a network device, may cause the apparatus at least to: receive, from a terminal device, capabilities of the apparatus comprising at least one of band combinations supported by the terminal device, fragmented carriers supported by the terminal device, and multiple operational states supported by the terminal device associated with MIMO reception across multiple antennas that enable multiple MIMO layers; and transmit, to the terminal device, a configuration comprising a transition between the multiple operational states, wherein one operational state of the multiple operational states is used to determine at least one of: a number of activated RX antennas or a number of RX chains.

In a ninth aspect, disclosed is an apparatus for a terminal device. The apparatus may comprise at least one processor and at least one memory. The at least one memory may store instructions that, when executed by the at least one processor, may cause the apparatus at least to: receive a carrier aggregation configuration comprising at least one combination of component carriers; and in response to receiving the carrier aggregation configuration, determine an operational state for receiving a configured combination of component carriers from the at least one combination of component carriers, wherein the operational state is used to determine at least one of: a number of activated RX antennas or a number of RX chains.

In a tenth aspect, disclosed is a method performed by an apparatus for a terminal device. The method may comprise: receiving a carrier aggregation configuration comprising at least one combination of component carriers; and in response to receiving the carrier aggregation configuration, determining an operational state for receiving a configured combination of component carriers from the at least one combination of component carriers, wherein the operational state is used to determine at least one of: a number of activated RX antennas or a number of RX chains.

In an eleventh aspect, disclosed is an apparatus for a terminal device. The apparatus may comprise: means for receiving a carrier aggregation configuration comprising at least one combination of component carriers; and means for in response to receiving the carrier aggregation configuration, determining an operational state for receiving a configured combination of component carriers from the at least one combination of component carriers, wherein the operational state is used to determine at least one of: a number of activated RX antennas or a number of RX chains.

In a twelfth aspect, a computer-readable medium is disclosed. The computer-readable medium may comprise program instructions that, when executed by an apparatus for a terminal device, may cause the apparatus at least to: receive a carrier aggregation configuration comprising at least one combination of component carriers; and in response to receiving the carrier aggregation configuration, determine an operational state for receiving a configured combination of component carriers from the at least one combination of component carriers, wherein the operational state is used to determine at least one of: a number of activated RX antennas or a number of RX chains.

Other features and advantages of the example embodiments of the present disclosure will also be apparent from the following description of specific embodiments when read in conjunction with the accompanying drawings, which illustrate, by way of example, the principles of example embodiments of the present disclosure.

### BRIEF DESCRIPTION OF THE DRAWINGS

Some example embodiments will now be described, by way of non-limiting examples, with reference to the accompanying drawings.

FIG. 1A shows an example sequence diagram according to the example embodiments of the present disclosure.

FIG. 1B shows an example sequence diagram according to the example embodiments of the present disclosure.

FIG. 1C shows an example sequence diagram according to the example embodiments of the present disclosure.

FIG. 2A shows an example operational state according to the example embodiments of the present disclosure.

FIG. 2B shows an example operational state with example diagram corresponding to FIG. 2A.

FIG. 3A shows an example operational state according to the example embodiments of the present disclosure.

FIG. 3B shows an example operational state with example diagram corresponding to FIG. 3A.

FIG. 4A shows an example operational state according to the example embodiments of the present disclosure.

FIG. 4B shows an example operational state with example diagram corresponding to FIG. 4A.

FIG. 5A shows an example operational state according to the example embodiments of the present disclosure.

FIG. 5B shows an example operational state with example diagram corresponding to FIG. 5A.

FIG. 6A shows an example of radio resource management (RRM) states for supporting a 4L DL MIMO intra-band non-contiguous band pair.

FIG. 6B shows an example operational state transition according to the example embodiments of the present disclosure.

FIG. 7A shows an example operational state according to the example embodiments of the present disclosure.

FIG. 7B shows an example operational state with example diagram corresponding to FIG. 7A.

FIG. 8A shows an example operational state according to the example embodiments of the present disclosure.

FIG. 8B shows an example operational state with example diagram corresponding to FIG. 8A.

FIG. 9A shows an example operational state according to the example embodiments of the present disclosure.

FIG. 9B shows an example operational state with example diagram corresponding to FIG. 9A.

FIG. 10A shows an example operational state according to the example embodiments of the present disclosure.

FIG. 10B shows an example operational state with example diagram corresponding to FIG. 10A.

FIG. 11 shows a flow chart illustrating an example method 1100 according to the example embodiments of the present disclosure.

FIG. 12 shows a flow chart illustrating an example method 1200 according to the example embodiments of the present disclosure.

FIG. 13 shows a flow chart illustrating an example method 1300 according to the example embodiments of the present disclosure.

FIG. 14 shows a block diagram illustrating an example device 1400 according to the example embodiments of the present disclosure.

FIG. 15 shows a block diagram illustrating an example device 1500 for authentication according to the example embodiments of the present disclosure.

FIG. 16 shows a block diagram illustrating an example apparatus 1600 according to the example embodiments of the present disclosure.

FIG. 17 shows a block diagram illustrating an example apparatus 1700 according to the example embodiments of the present disclosure.

FIG. 18 shows a block diagram illustrating an example apparatus 1800 according to the example embodiments of the present disclosure.

Throughout the drawings, same or similar reference numbers indicate same or similar elements. A repetitive description on the same elements would be omitted.

### DETAILED DESCRIPTION

Herein below, some example embodiments are described in detail with reference to the accompanying drawings. The following description includes specific details for the purpose of providing a thorough understanding of various concepts. However, it will be apparent to those skilled in the art that these concepts may be practiced without these specific details. In some instances, well known circuits, techniques and components are shown in block diagram form to avoid obscuring the described concepts and features.

Example embodiments of the present disclosure provide solutions for supporting fragmented carriers as well as inter-band CA. According to the example embodiments of the present disclosure, a UE may transition among multiple operational states by altering, for example, RX antenna ports to support fragmented carriers and inter-band CA in, e.g., 5G CA, such that reception conditions can be improved and/or the amount of inter-band and intra-band simultaneous connections can be increased. The operational state may comprise, for example, hardware state, which may also be referred to as hardware configuration.

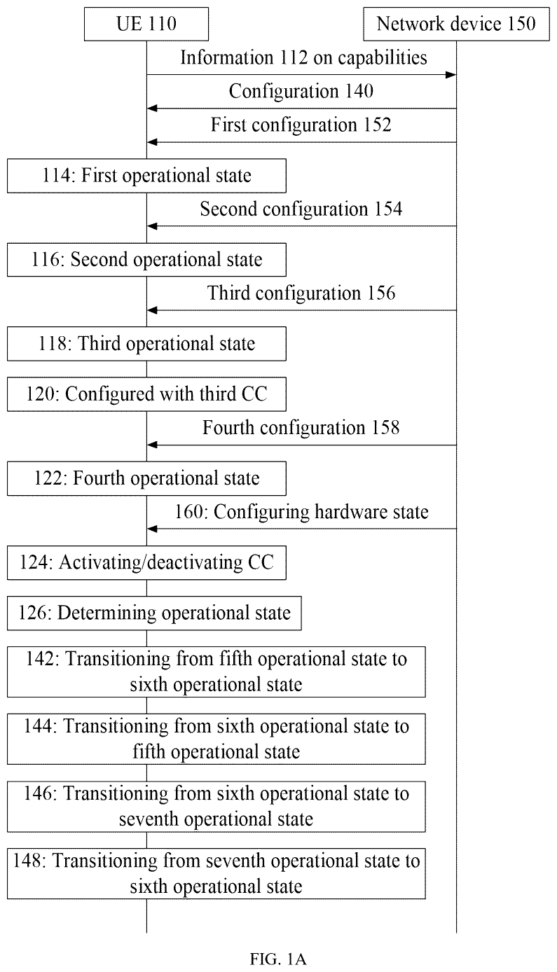

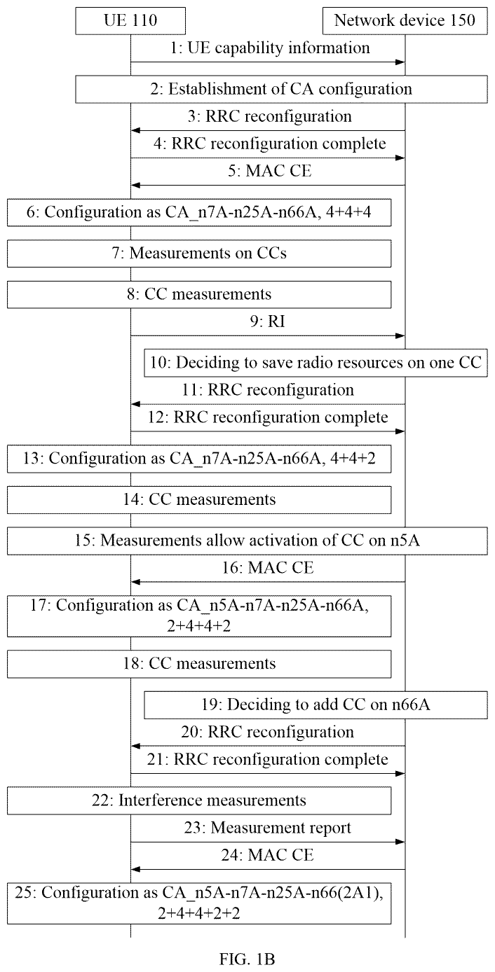

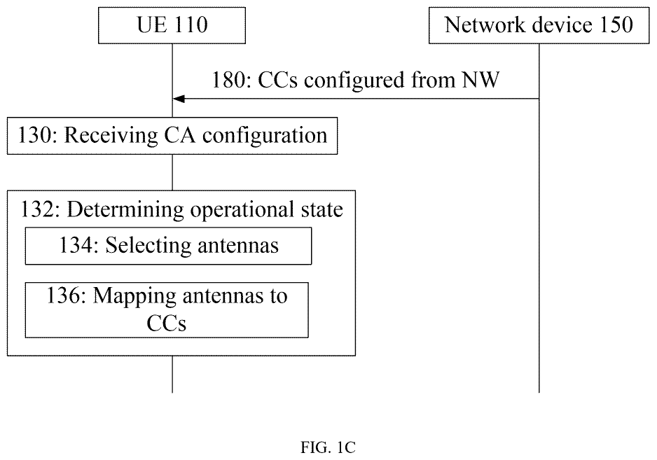

FIG. 1A shows an example sequence diagram according to the example embodiments of the present disclosure. Referring to FIG. 1, a UE 110 may represent any terminal device in a network, a network device 150 may represent the network serving the UE 110. The network device 150 may function as a network node/a base station (BS), such as a next Generation Node B (gNB), etc.

The UE 110 may transmit to the network device 150 information 112 on capabilities of the UE 110. In some embodiments, the capabilities of the UE 110 may comprise at least one of band combinations supported by the UE 110, fragmented carriers supported by the UE 110, and multiple operational states supported by the UE 110 associated with MIMO reception across multiple antennas that enable multiple MIMO layers.

In some embodiments, one operational state of the multiple operational states may be a combination of at least one of: a number of MIMO layers, a number of RX chains, and analog filter bandwidth. In some embodiments, the number of MIMO layers may be more than one, e.g. 2 layers or 4 layers; the number of RX chains may comprise at least one of: 1 RX chain, 2 RX chains per MIMO layer; and the analog filter bandwidth may comprise: either a first analog filter bandwidth, or a second analog filter bandwidth, and the first analog bandwidth is narrower than the second analog bandwidth.

In some embodiments, the UE 110 may be configured to support the multiple operational states of a same activation of hardware to support different levels of CA based on at least one of the followings: presence of in-gap interference; inter-band combination demand; number of connectable RX antennas; or actual MIMO rank. In some embodiments, the network device 150 may configure the UE 110 to support the multiple operational states of the same activation of hardware to support different levels of CA based on at least one of the followings: presence of in-gap interference; inter-band combination demand; number of connectable RX antennas; or actual MIMO rank. The same activation of hardware may refer to the same hardware structure. The levels of CA may involve the CCs the UE 110 can simultaneously support, which may comprise the case where the periods for the CCs are aligned and also the case where the periods for the CCs partly overlap.

In some embodiments, the capabilities may comprise capabilities of the UE 110 to support one or more operational states associated with MIMO reception across multiple antennas that enable multiple MIMO layers. The capabilities may also comprise capabilities of the UE 110 to support a set of configured component carriers (CCs) on one or more bands. In some embodiments, the UE 110 may report the capabilities upon registration on the network device 150. In some embodiments, the UE 110 also report interference level, e.g. level of in-gap interference.

In some embodiments, the capabilities of the UE 110 to support one or more operational states may involve at least one of the following aspects: the number of active RX antennas the UE 110 can use for a configured CC, whether the UE 110 can deactivate a number of RX antennas for a configured CC, whether the UE 110 can use the deactivated antennas for other purpose, or whether the UE 110 can use a wider analogue filter.

In some embodiments, the set of configured CCs may be all the CCs the UE 110 can support. Alternatively, in some embodiments, the set of configured CCs may be a part of the CCs the UE 110 can support. In some embodiments, the set of configured CCs may comprise multiple combinations of the CCs the UE 110 can support.

In some embodiments, the capabilities of the UE 110 to support the CCs may refer to the capabilities to support the CCs configured simultaneously by the network, which may comprise the case where the configured periods for the CCs are aligned and also the case where the configured periods for the CCs partly overlap.

In some embodiments, the set of configured CCs may comprise fragmented CCs, or referred to as non-contiguous CCs, and in some embodiments the set of configured CCs may further comprise inter-band CCs. The combinations of the CCs may comprise combinations of intra-band CCs and combinations of inter-band CCs.

In some embodiments, the one or more bands may comprise at least n7, n25, and n66.

Receiving the information 112 on the capabilities of the UE 110, the network device 150 may determine a CA configuration for the UE 110 based on the information 112.

In some embodiments, the operational state of the UE 110 may be determined by the network. For example, the network device 150 may determine the operational state of the UE 110 for a combination of the configured CCs, using at least one of the following conditions: presence of in-gap interference, inter-band combination demand, a number of connectable receive antennas, or an actual MIMO rank. The MIMO rank may refer to the number of independent data streams that can be transmitted simultaneously over the MIMO chains. The operational state may further comprise the purpose of deactivated RX antennas for a CC, and the deactivated RX antennas for a CC may refer to deactivated RX chains at antenna modules.

In some embodiments, the network device 150 may transmit to the UE 110, a configuration 140 of a transition between the multiple operational states, wherein one operational state of the multiple operational states may be used to determine at least one of: a number of activated RX antennas or a number of RX chains.

In some embodiments, the number of the RX chains for a same carrier may be determined based on a receive condition at the UE 110, wherein poorer receive condition demands larger number of RX chains, and better receive condition relaxes the number of RX chains. The number of the RX chains for the same carrier may be determined by either the UE 110 or the network device 150. In some embodiments, when the receive condition is above a threshold, the UE 110 may deactivate at least one RX chain of the same carrier, and the deactivated at least one RX chain may be used as spare RX chain. The deactivation of the at least one RX chain of the same carrier may be determined by either the UE 110 or the network device 150. That is, for a CC, if the receive condition is good, less number, e.g. 2, of RX chains may be sufficient. On the contrary. if the receive condition is bad, more RX chains, e.g. 4 RX chains, may be required.

In some embodiments, the at least one spare RX chain may be used for at least one of: increasing inter-band combinations or increasing fragments in fragmented carrier aggregation band of the band combinations.

In some embodiments, the network device 150 may transmit to the UE 110, a first configuration 152 comprising at least a subset of the configured CCs, on at least a first band of the one or more bands, belonging to the set and at least a first operational state for the subset.

In some embodiments, the first configuration 152 may be transmitted via a radio resource control (RRC) message, for example, an RRC reconfiguration message, and receiving the first configuration 152, the UE 110 may transmit to the network device 150, for example, an RRC reconfiguration complete message.

The first configuration 152 may correspond to the first operational state and may indicate the UE 110 to transition to or remain in the first operational state. In response to the subset of the configured CCs, in an operation 114 the UE 110 may transition to or remain in the first operational state where a first number of antennas are used for the subset of the configured CCs. In case the UE 110 is in the first operational state when receiving the first configuration 152, the UE 110 may remain in the first operational state. In case the UE 110 is not in the first operational state when receiving the first configuration 152, the UE 110 may transition to the first operational state. The network device 150 may activate the configured CCs via, e.g. a medium access control (MAC) control element (MAC CE), when the configured CCs are to be used, and the UE 110 may transition to the first operational state before, after, or in parallel to the activation of the configured CCs.

In some embodiments, the first configuration 152 may be comprised in the configuration 140 of the transition between the multiple operational states. According to the first configuration 152, the UE 110 may transition to or remain in the first operational state. In some embodiments, the first configuration 152 may comprise multiple configured CCs, on at least a first band of the band combinations, and in the first operational state, for a CC of the multiple configured CCs, a first number of RX chains may be activated.

In some embodiments, the multiple configured component carriers comprise three component carriers with each one on three individual bands; on the respective bands, the number of MIMO layers is 4; the first number of the activated RX chains is 2, and the first analog filter bandwidth with narrower bandwidth than the second analog filter bandwidth is used for each of the activated RX chains.

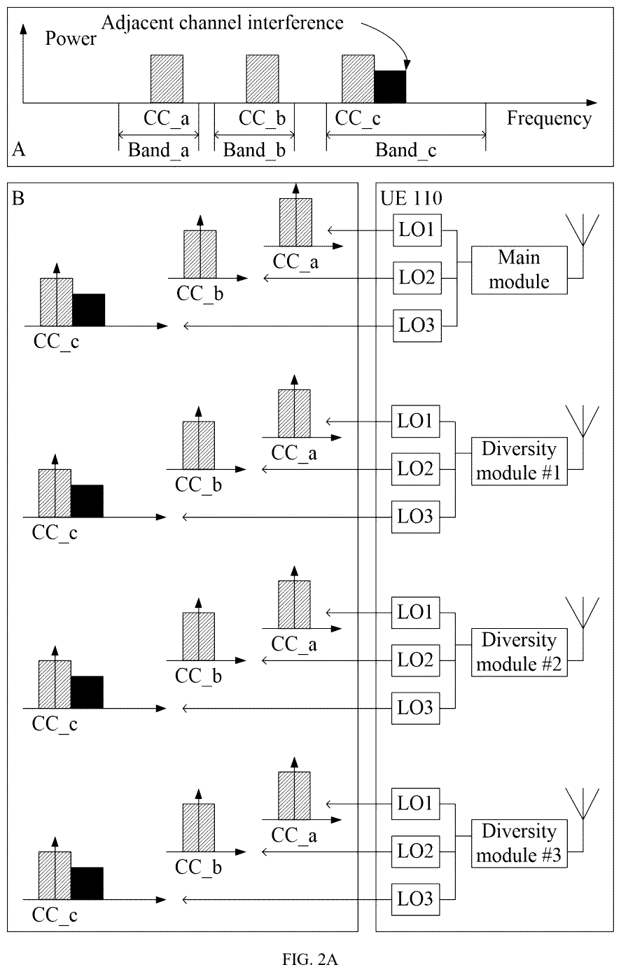

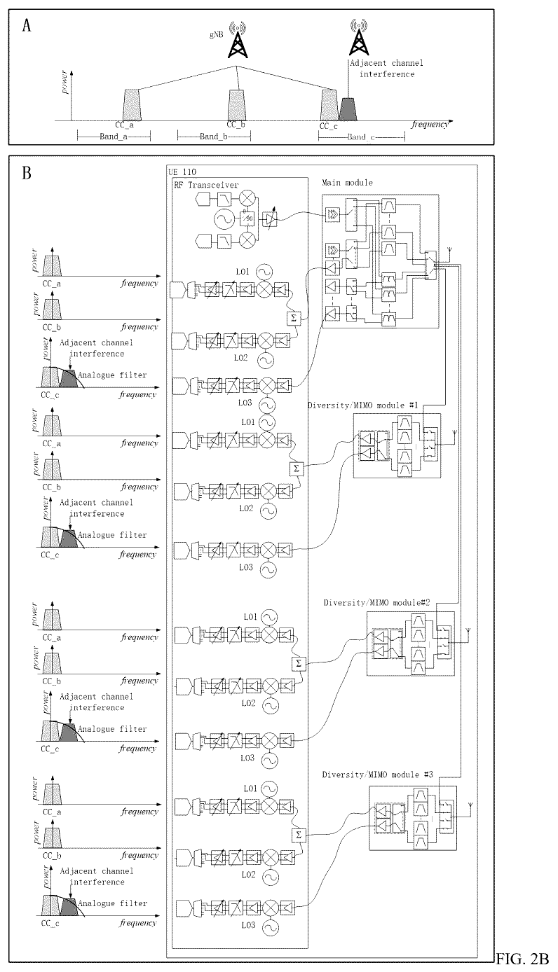

FIG. 2A shows an example operational state according to the example embodiments of the present disclosure. FIG. 2B shows an example operational state with example diagram corresponding to FIG. 2A. Referring to FIG. 2A and FIG. 2B, block A shows an example of downlink (DL) signal input into the antennas of the UE 110, the block of the UE 110 shows an example of the first hardware state, and block B shows an example of the DL signal processed by the UE 110. And FIG. 2B further shows in RF transceiver each LO is associated with an RX chain, as well as a gNB serving the UE 110 and adjacent channel interference caused by other gNB(s). In present disclosure, usage or deactivation of an LO and/or an RX chain refers to the usage or the deactivation of the LO and the associated RX chain. And in present disclosure, an RF chain may be used as the RX chain.

Referring to block A, the subset of the configured CCs may comprise three CCs on three bands, respectively, CC_a on band_a, CC_b on band_b, and CC_c with adjacent channel interference on band_c. In some embodiments, band_a, band_b, and band_c may be, for example, of n25, n66, and n7, and band_a, band_b, and band_c may be in any mapping relationship to n25, n66, and n7.

The ULE 110 may use 4 MIMO layers, and the antenna modules of the UE 110 may comprise a main module and three diversity modules. The main module may be, for example, a front-end module, and the three diversity modules may be denoted as diversity module #1, diversity module #2, and diversity module #3. Diversity module may also be referred to as diversity/MIMO module. Each of the modules may use one or more local oscillators (LOs), and in this case three LOs are denoted as LO1, LO2, and LO3.

As shown in FIG. 2A and FIG. 2B, the UE 110 uses four antennas for the subset of the configured CCs, i.e. first number=4. In some embodiments, the first number may be the full number of the antennas of the UE 110, and in this case, UE 110 uses all antennas for the subset of the configured CCs. In some embodiments, the first number may less than the full number, and in this case, UE 110 uses a part of antennas for the subset of the configured CCs.

In the example first operational state, the UE 110 uses four antennas for each of the configured CCs. In each of the main module, diversity module #1, diversity module #2, and diversity module #3, for example, the UE 110 may use LO1 for CC_a, LO2 for CC_b, and LO3 for CC_c, and the UE 110 also use an analogue filter shown for the example with LO3 to suppress the adjacent channel and in-band interference. FIG. 2A and FIG. 2B show an example, and the example embodiments are not limited to FIG. 2A and FIG. 2B. For example, the UE 110 may employ other corresponding patterns of LOs and CCs. For example, the UE 110 may use LO2 for CC_a and LO1 for CC_b. Alternatively, for example, the UE 110 may use LO1 for CC_c and LO3 for CC_a.

In the example first operational state, in some embodiments, for CC_a, CC_b, and CC_c, the MIMO rank may be four. In some embodiments, in case band_a, band_b, and band_c are of n25, n66 and n7, band_a, band_b, and band_c may be in any mapping relationship to n25, n66, and n7, and the supported MIMO layers for bands may be denoted as, for example, CA_n7A-n25A-n66A=4+4+4.

The UE 110 may measure CC_a, CC_b, and CC_c for quality, etc. and report to the network device 150, the measured quality and rank indicator (RI), which may suggest the number of MIMO layers (or the MIMO rank) the UE 110 can support based on the current channel conditions.

In some cases, for example, the measured quality for a CC is good, and/or the network device 150 wants to save radio resources on a CC, the network device 150 may decide to downscale or downgrade the MIMO layer for the CC.

Referring back to FIG. 1A, in some embodiments, the network device 150 may transmit to the UE 110, a second configuration 154 comprising a reduced number of active antennas for a first CC of the subset. In some embodiments, the second configuration 154 may be transmitted via an RRC message, for example, an RRC reconfiguration message, and receiving the second configuration 154, the UE 110 may transmit to the network device 150, for example, an RRC reconfiguration complete message.

The second configuration 154 may correspond to a second operational state and may indicate the UE 110 to transition to or remain in the second operational state. According to the second configuration 154, in an operation 116 the UE 110 may transition to or remain in the second operational state where the reduced number of active antennas is used for the first CC and a number of antennas beyond the reduced number of antennas are deactivated. In case the UE 110 is in the second operational state when receiving the second configuration 154, the UE 110 may remain in the second operational state. In case the UE 110 is not in the second operational state when receiving the, the UE 110 may transition to the second operational state.

In some embodiments, the second configuration 154 may be comprised in the configuration 140 of the transition between the multiple operational states. According to the second configuration 154, the UE 110 may transition to or remain in the second operational state. In some embodiments, the second configuration may comprise the multiple configured CCs, and in the second operational state, for a first CC of the multiple configured CCs, a number, reduced from the first number, of RX chains may be activated for the first CC and a number of RX chains beyond the reduced number may be deactivated.

In some embodiments, the first component carrier is on the first band, the multiple configured component carriers are on the first band and two additional bands; on the respective two component carriers configured on the two additional band, the number of MIMO layers is 4; the first number of the activated RX chains is 2, and the first analog filter bandwidth with narrower bandwidth than the second analog filter bandwidth is used; on the first component carrier of the first band, the number of MIMO layers is 2; the number of the activated RX chains is 1, and the first analog filter bandwidth with narrower bandwidth than the second analog filter bandwidth is used.

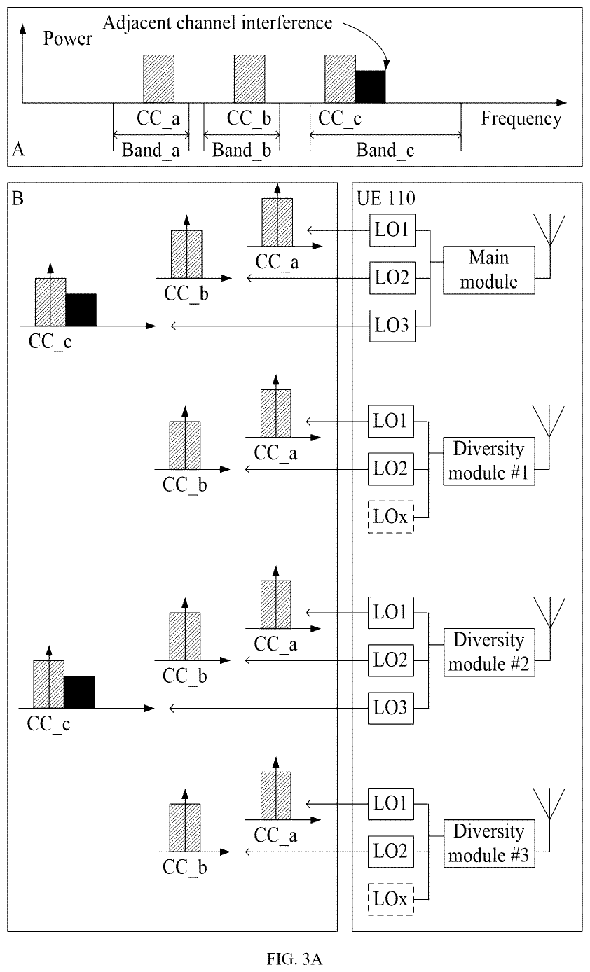

FIG. 3A shows an example operational state according to the example embodiments of the present disclosure. FIG. 3B shows an example operational state with example diagram corresponding to FIG. 3A. Referring to FIG. 3A and FIG. 3B, block A shows an example of DL signal input into the antennas of the UE 110, the block of the UE 110 shows an example of the second hardware state, and block B shows an example of the DL signal processed by the UE 110. And FIG. 3B further shows in RF transceiver each LO is associated with an RX chain, as well as a gNB serving the UE 110 and adjacent channel interference caused by other gNB(s).

Referring to block A, the DL signal may be the same as that in FIG. 2A and FIG. 2B. The operational structure itself of the UE 110 may be the same as that in FIG. 2A and FIG. 2B.

In the example second operational state, assuming that the first CC is CC_c, as shown in FIG. 3A, the UE 110 may use four antennas for CC_a and CC_b and use a reduced number of active antennas, e.g., 2 antennas in the main module and diversity module #2, for the CC_c, and the UE 110 may also use an analogue filter with LO3 at the main module and diversity module #2 to suppress the adjacent channel and in-band interference. As shown in FIG. 3A, the UE 110 may deactivate a number of antennas beyond the reduced number of antennas, e.g., the antennas in diversity module #1 and diversity module #3, and, for example, one RX chain at diversity module #1 and diversity module #3 may be deactivated, or referred to as “being freed up.” In FIG. 3A and FIG. 3B, LOx is shown as deactivated, which may represent any LO other than the used LO at the modules that supports a connection to the receive chain. FIG. 3A and FIG. 3B show an example, and the example embodiments are not limited to FIG. 3A and FIG. 3B. For example, the reduced number of LOs may be used for other CC.

In the example second operational state, in some embodiments, for CC_a, CC_b, and CC_c, the MIMO rank may be two, four, and four, respectively. In some embodiments, in case band_a, band_b, and band_c are of n25, n66, and n7, band_a, band_b, and band_c may be in any mapping relationship to n25, n66, and n7, and the supported MIMO layer for bands may be denoted as, for example, CA_n7A-n25A-n66A=4+4+2. The UE 110 has a spare RX chain.

The UE 110 may measure CC_a, CC_b, and CC_c for quality, etc. and report to the network device 150, the measured quality and RI.

In some cases, for example, the measured quality allows an activation of a carrier on an additional band other than the subset, the network device 150 may decide to activate the carrier on the additional band, e.g., n5A.

Referring back to FIG. 1A, in some embodiments, the network device 150 may transmit to the UE 110, a third configuration 156 comprising a second CC on a band besides the band of the subset, previously used. In some embodiments, the third configuration 156 may be transmitted via an RRC message, for example, an RRC reconfiguration message, and receiving the third configuration 156, the UE 110 may transmit to the network device 150, for example, an RRC reconfiguration complete message.

The third configuration 156 may correspond to a third operational state and may indicate the UE 110 to transition to or remain in the third operational state. In response to the second CC being configured, in an operation 118 the UE 110 may transition to or remain in the third operational state where the deactivated antennas are used for the second CC. In case the UE 110 is in the third operational state when receiving the third configuration 156, the UE 110 may remain in the third operational state. In case the UE 110 is not in the third operational state when receiving the third configuration 156, the UE 110 may transition to the third operational state. The network device 150 may activate the second CC via, e.g. a MAC CE, when the second CC is to be used, and the UE 110 may transition to the third operational state before, after, or in parallel to the activation of the second CC.

In some embodiments, the third configuration 156 may be comprised in the configuration 140 of the transition between the multiple operational states. According to the third configuration 156, the UE 110 may transition to or remain in the third operational state. In some embodiments, the third configuration 156 may comprise a second CC on a band besides the band combinations previously used, and in the third operational state, the deactivated RX chains may be activated for the second CC.

In some embodiments, the second component carrier of the multiple configured component carriers is on a fourth band besides the band combinations of the three previously used bands; on the second component carrier on the fourth band of, the number of MIMO layers is 2; the number of the activated RX chains is 1, and the first analog filter bandwidth with narrower bandwidth than the second analog filter bandwidth is used; on respective two component carriers of the second and third bands, the number of MIMO layers is 4; the first number of the activated RX chains is 2, and the first analog filter bandwidth with narrower bandwidth than the second analog filter bandwidth is used; on the first component carrier of the first band, the number of MIMO layers is 2; the number of the activated RX chains is 1, and the first analog filter bandwidth with narrower bandwidth than the second analog filter bandwidth is used.

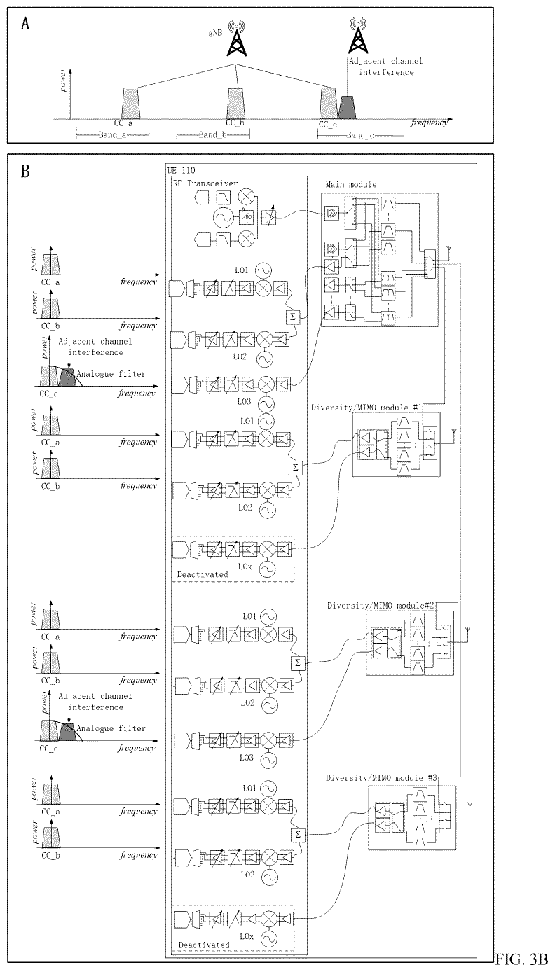

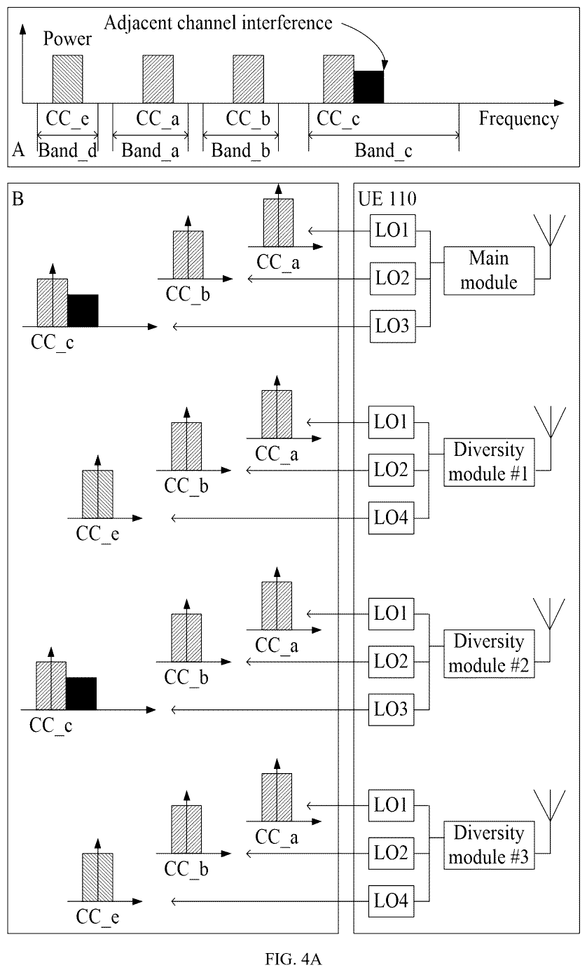

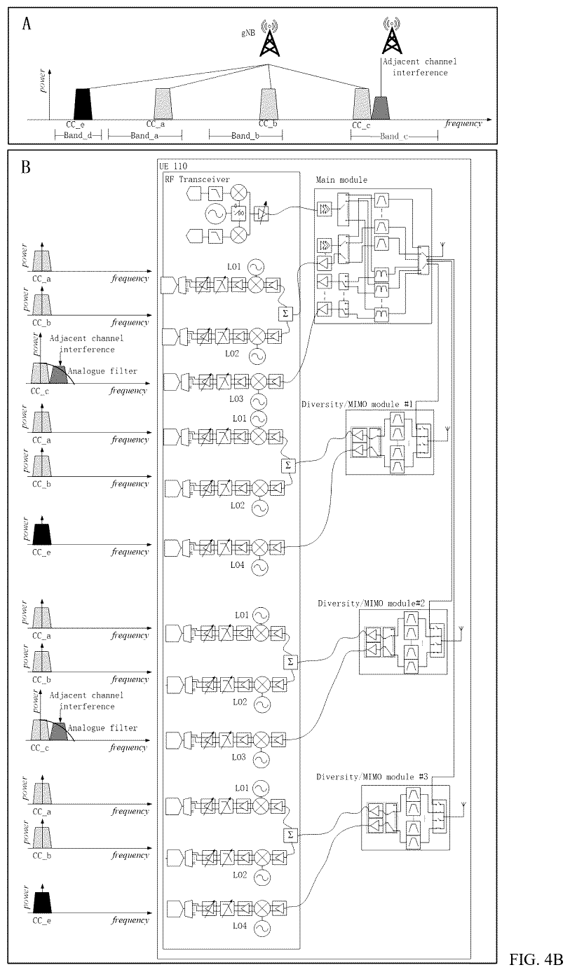

FIG. 4A shows an example operational state according to the example embodiments of the present disclosure. FIG. 4B shows an example operational state with example diagram corresponding to FIG. 4A. Referring to FIGS. 4A and 4B, block A shows an example of DL signal input into the antennas of the UE 110, the block of the UE 110 shows an example of the third hardware state, and block B shows an example of the DL signal processed by the UE 110. And FIG. 4B further shows in RF transceiver each LO is associated with an RX chain, as well as a gNB serving the UE 110 and adjacent channel interference caused by other gNB(s).

Referring to block A, compared to the DL signal in FIG. 2A and FIG. 2B or FIG. 3A and FIG. 3B, the DL signal further comprise CC_e on band_d. Band_d is the band besides the band of the subset, previously used, and CC_e is the second CC. The operational structure itself of the UE 110 may be also the same as that in FIG. 2A and FIG. 2B or FIG. 3A and FIG. 3B.

In the example third operational state, as shown in FIGS. 4A and 4B, for CC_e, the UE 110 may use the deactivated antennas, e.g. the deactivated antennas in diversity module #1 and diversity module #3 shown in FIG. 2A and FIG. 2B, i.e. the RX chains of LO4 at diversity module #1 and diversity module #3. FIGS. 4A and 4B show an example, and the example embodiments are not limited to FIGS. 4A and 4B. For example, if the RX chains of LO3 in, i.e, FIG. 3A at diversity module #1 and diversity module #3 are deactivated, the UE110 may use the RX chains of LO3 at diversity module #1 and diversity module #3 for CC_e, and other LO, e.g. LO4 at the main module and diversity module #2 may be used for CC_c, while LO3 remains at active at main module and diversity module #2.

In the example third operational state, in some embodiments, for CC_e, CC_a, CC_b, and CC_c, the MIMO rank may be two, four, four, and two, respectively. In some embodiments, in case band_a, band_b, band_c, and band_d are of n7, n25, n66, and n5, band_a, band_b, band_c, and band_d may be in any mapping relationship to n25, n66, n7, and n5, and the supported MIMO layer for bands may be denoted as, for example, CA_n5A-n7A-n25A-n66A=2+4+4+2. The UE 110 spends a spare RX chain on an inter-band CC, i.e. CC_e. Thus, the deactivated antennas/RX chains may support increased inter-band combinations or more fragmented CCs in the fragmented CA band.

The UE 110 may measure CC_e, CC_a, CC_b, and CC_c for quality, etc. and report to the network device 150, the measured quality and RI.

In some cases, the network device 150 may decide to an additional carrier for a band of the subset, for example, adding a non-contiguous intra-band CC on the band having a configured CC already.

Referring back to FIG. 1A, in some embodiments, the network device 150 may transmit to the UE 110, a fourth configuration 158 comprising a third CC on the first band. In some embodiments, the fourth configuration 158 may be transmitted via an RRC message, for example, an RRC reconfiguration message, and receiving the fourth configuration 158, the UE 110 may transmit to the network device 150, for example, an RRC reconfiguration complete message.

The fourth configuration 158 may correspond to a fourth operational state and may indicate the UE 110 to transition to or remain in the fourth operational state. In response to the third CC being configured, in an operation 122 the UE 110 may transition to or remain in the fourth operational state where the first band for receiving a fourth CC is reconfigured for receiving the third CC while also receiving the fourth CC utilizing a wider analogue filter, which may support non-contiguous intra-band CCs and allow an unattenuated passage of the in-gap interferer. In case the UE 110 is in the fourth operational state when receiving the fourth configuration 158, the UE 110 may remain in the fourth operational state. In case the UE 110 is not in the fourth operational state when receiving the fourth configuration 158, the UE 110 may transition to the fourth operational state.

The network device 150 may activate the third CC via, e.g. a MAC CE, when the third CC is to be used, and the UE 110 may transition to the fourth operational state before, after, or in parallel to the activation of the third CC. In some embodiments, the UE 110 may measure the in-gap interferer and report to the network device 150 the measured in-gap interference. In case there is no presence of the in-gap interference on the first band or the in-gap interference is lower than a threshold, the network device 150 may activate the third CC because a wider analogue filter may be used on the first band.

In some embodiments, the fourth configuration 158 may be comprised in the configuration 140 of the transition between the multiple operational states. According to the fourth configuration 158, the UE 110 may transition to or remain in the fourth operational state. In some embodiments, the fourth configuration may comprise a third CC on the first band, and in the fourth operational state, the first band having been configured to receive a fourth CC may be reconfigured for receiving the third CC while also receiving the fourth CC, and a second analog filter which has wider bandwidth may be used on the first band.

In some embodiments, the third component carrier and the fourth component carrier are both on the first band; on the fourth band, the number of MIMO layers is 2; the number of the activated RX chains is 1, and the first analog filter bandwidth with narrower bandwidth than the second analog filter bandwidth is used; on respective two component carriers of the second and third bands, the number of MIMO layers is 4; the first number of the activated RX chains is 2, and the first analog filter bandwidth with narrower bandwidth than the second analog filter bandwidth is used; on the respective one of the third and the fourth component carriers on the first band, the number of MIMO layers is 2; the number of the activated RX chains is 1, and the second analog filter bandwidth with wider bandwidth than the first analog filter bandwidth is used.

In some embodiments, the first band is n66, the second band is n7, the third band is n25, and/or the fourth band is n5.

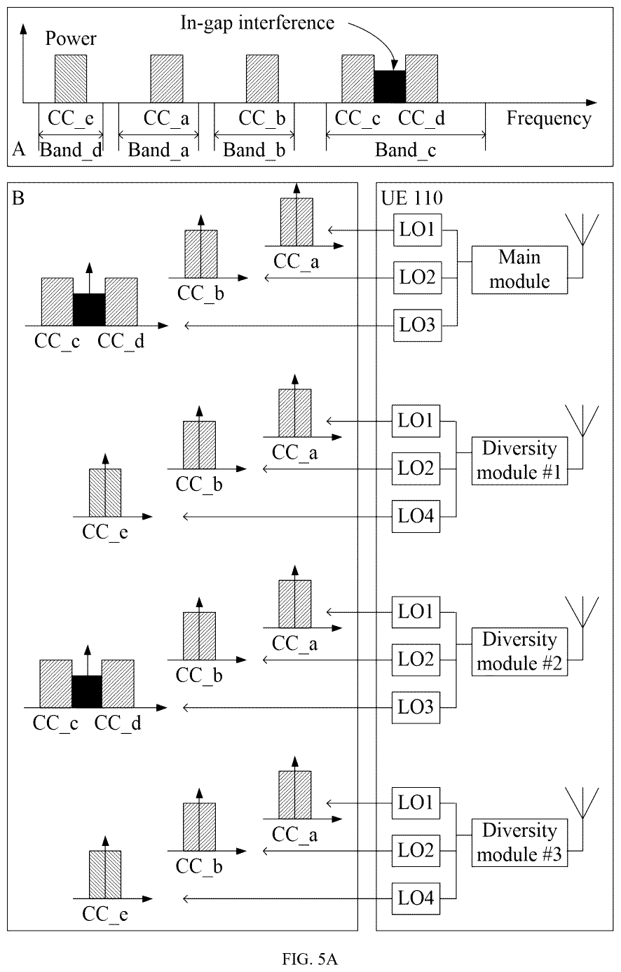

FIG. 5A shows an example operational state according to the example embodiments of the present disclosure. FIG. 5B shows an example operational state with example diagram corresponding to FIG. 5A. Referring to FIG. 5A and FIG. 5B, block A shows an example of DL signal input into the antennas of the UE 110, the block of the UE 110 shows an example of the fourth operational state, and block B shows an example of the DL signal processed by the UE 110. And FIG. 5B further shows in RF transceiver each LO is associated with an RX chain, as well as a gNB serving the UE 110 and in-gap interference caused by other gNB(s).

Referring to block A, compared to the DL signal in FIGS. 4A and 4B, the DL signal further comprise CC_d on band_c. On band_c, there is already CC_c configured and activated. Band_c is the first band, CC_c is the fourth CC, and CC_d is the third CC. The hardware structure itself of the UE 110 may be also the same as that in FIG. 2A and FIG. 2B, FIG. 3A and FIG. 3B or FIG. 4A and FIG. 4B.

In the example fourth operational state, as shown in FIG. 5A and FIG. 5B, the band_c for receiving CC_c is reconfigured for receiving the CC_d while also receiving the CC_c utilizing a wider analogue filter. As shown in FIG. 5A and FIG. 5B, antennas in the main module and diversity module #2, e.g., the RX chains of LO3 at the main module and diversity module #2 are used for CC_c and CC_d with the usage of the wider analogue filter. FIG. 5A and FIG. 5B show an example, and the example embodiments are not limited to FIG. 5A and FIG. 5B. For example, an inter-band CC may be configured and activated on other band(s), e.g. band_a and/or band_b.

In the example fourth operational state, in some embodiments, for CC_e, CC_a, CC_b, CC_c, and CC_d, the MIMO rank may be two, four, four, two, and two, respectively. In some embodiments, in case band_a, band_b, band_c, and band_d are of n7, n25, n66, and n5, band_a, band_b, band_c, and band_d may be in any mapping relationship to n25, n66, n7, and n5, and the supported MIMO layer for bands may be denoted as, for example, CA_n5A-n7A-n25A-n66(2A1)=2+4+4+2+2, where the syntax n66(2A1) indicates reception of non-contiguous intra-band CA using 1 RX chain (with wider analogue filter). The UE 110 supports an intra-band CA on n66 by using a wider analogue filter, or referred to, as a wider channel filter. The UE 110 support a 2+4+4+2+2 layer MIMO by 12 radio frequency (RF) receive paths.

The UE 110 may measure CC_e, CC_a, CC_b, CC_c, and CC_d for quality, etc. and report to the network device 150, the measured quality and RI.

The network device 150 may transmit at least one of the first configuration 152, the second configuration 154, the third configuration 156, or the fourth configuration 158 in a single message or separate messages. For example, the UE 110 may receive the first configuration 152, the second configuration 154, the third configuration 156, or the fourth configuration 158 in one message. Alternatively, for example, the UE 110 may receive the second configuration 154 and the third configuration 156 in one message and receive the first configuration 152 and/or the fourth configuration 158 in other message(s).

The first, second, third, and fourth configurations and the first, second, third, and fourth operational states are examples, and the example embodiments of the present disclosure may support other configurations and other operational states. For example, 4 layer MIMO fragmented CCs can be enabled on band_a and band_b, e.g. on both n7 and 25, if in-gap interference on band_a and band_b is low enough. For example, CC_e on band_d, e.g. n5, can be removed, and the CC pair of CC_c and CC_d on band_c, e.g. n66, can be upgraded to 4 layer MIMO, e.g. by further using RX chains of LO3 at diversity module #1 and diversity module #3 for CC_c and CC_d.

In case the UE 110 has been configured with the third CC on the first band in an operation 120 before receiving the fourth configuration 158, the transmission of the fourth configuration 158 may be saved. In this case, the UE 110 may receive the third CC without an RRC signaling. For example, in case the in-gap interference on the first band is lower than a threshold, the UE may automatically activate and receive the third CC and transition to or remain in the fourth operational state where the first band for receiving the fourth CC is used for receiving the third CC while also receiving the fourth CC utilizing the wider analogue filter. In this case, the UE 110 may report to the network device 150 that the UE 110 is currently in the fourth operational state. In some embodiments, the first configuration 152 may comprise the set of the configured CCs and multiple operational states corresponding to multiple combinations of the set of the configured CCs. For example, based on the operational capabilities on hardware of the UE 110, the network device 150 may include multiple possibilities of combinations of CCs and multiple operational states for the multiple combinations of CCs in the first configuration 152. Thus, other configurations such as the second configuration 154, the third configuration 156, and the fourth configuration 158 may be unnecessary, and if the network device 150 changes the MIMO rank and/or decide whether a wider analogue filter can be used by the UE 110, the UE 110 may automatically activate or deactivate a CC. Therefore, in some embodiments, the network could configure multiple options that could be active depending on MIMO and fragmented carrier state, which means that if the MIMO mode is changed by the network, an additional carrier could automatically become active or de-activated.

For example, in some embodiments, in an operation 160 the network device 150 may determine an operational state, from the multiple operational states, for the UE 110 to activate or deactivate a CC according to the determined operational state. From the perspective of UE 110, in some embodiments, receiving the first configuration 152, in an operation 124 the UE 110 may activate or deactivate a CC according to an operational state, from the multiple operational states, configured from the network device 150. In some embodiments, the UE 110 may report to the network device 150, the activation or deactivation of a CC.

Alternatively, or additionally, in some embodiments, in case the first configuration 152 comprise the set of the configured CCs and multiple operational states corresponding to multiple combinations of the set of the configured CCs, in an operation 126, the UE 110 may determine an operational state from the multiple operational states for a combination of the configured CCs from the multiple combinations by itself. In this case, the UE 110 could be involved in the compromises between the selection of MIMO layers and the selection of the CCs to be used. For example, in some embodiments, the UE 110 may determine an operational state using at least one of the following conditions: presence of in-gap interference, inter-band combination demand, a number of connectable receive antennas, or an actual MIMO rank. Then, the UE 110 may transition to or remain in the determined operational state. Exactly which transitions are available may depend on the signaling solution selected for MIMO and fragmented carriers.

In some embodiments, the multiple operational states in the first configuration 152 may comprise or involve at least one of the following: different number of active antennas used for a configured CC, a number of antennas deactivated, usage of deactivated antennas, or usage of wider analogue filter.

The example embodiments can establish the potential of applying the wider analogue filtering for reception of fragmented CA and consider the support of only the minimum mandated receiver RX antennas. A UE with the same hardware may transition to much more advanced CA configurations that allow much higher throughputs in fragmented spectrum bands such as n7, n25, and n66. The operational states in the example embodiments makes it clear that a UE can be reconfigured at any time to apply LOs, analogue filters and antenna routing, that the UE can transition between UE hardware states of different receiver performances with aspects both of supported RX antennas and carrier interference suppression (width of analogue filter).

In some example embodiments, several CA configurations may have different applicability. Table 1 shows an example of CA configurations in some example embodiments.

TABLE 1

| | |
|---|---|
| CA_n7A-n25A-n66A | 4 + 4 + 4 |
| CA_n7A-n25A-n66A | 4 + 4 + 2 |
| | 1 spare RX chain |
| CA_n7A-n25A-n66(2A) | 4 + 4 + 2 + 2 |
| | RX chain spent on fragmented CA |
| | support |
| CA_n7A-n25A-n66(2A1) | 4 + 4 + 4 + 4 |
| | RX chain spent on fragmented CA |
| | support (using wider channel |
| | filter, increasing MIMO rank) |

CA_n7A-n25A-n66A(2A1) 4+4+4+4 can achieve the same objective to free an RX chain as CA_n7A-n25A-n66(2A) 4+4+2+2, and the usage the wider analogue filter allows 4 antennas, which is one way to improve receiver quality, if interference in the gap is low. The reduction to two antennas can become resilient to the interference in the gap. A configuration supporting the first row of Table 1 is shown in e.g. FIG. 2A and FIG. 2B.

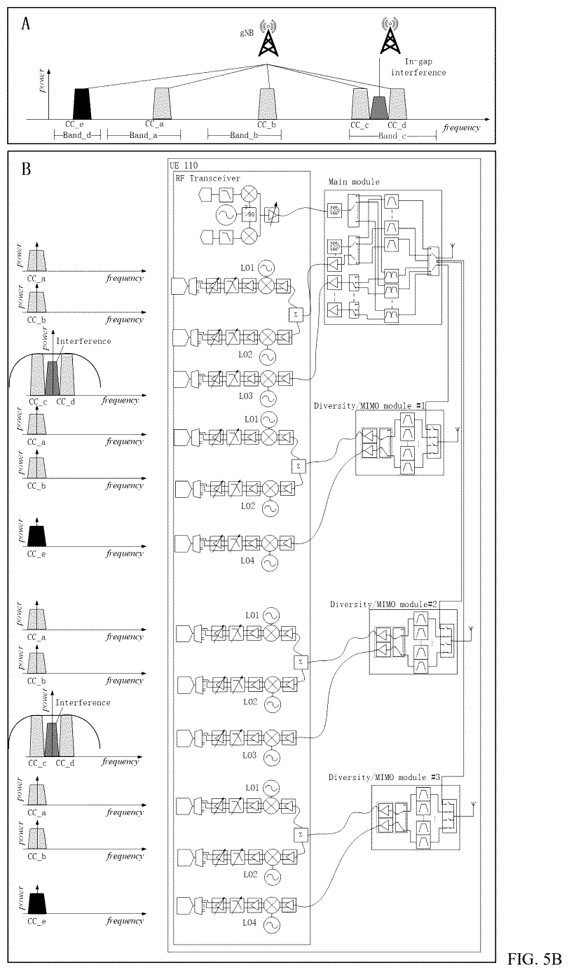

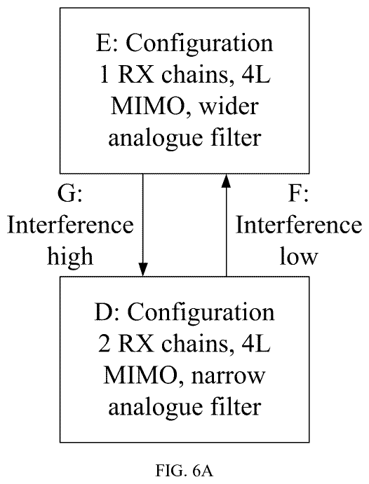

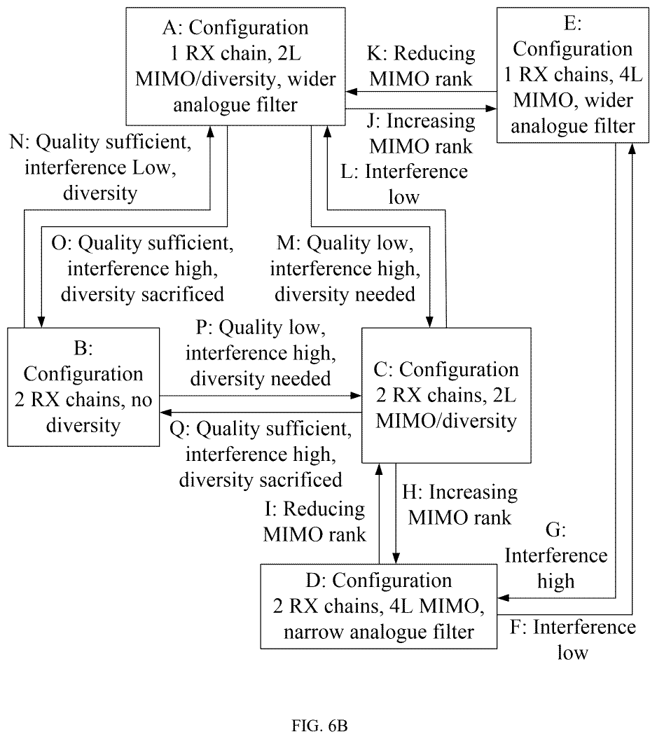

FIG. 6A shows an example of radio resource management (RRM) states for supporting a 4L DL MIMO intra-band non-contiguous band pair.

Referring to block D, in this operational state, the UE 110 may run a 4L DL MIMO intra-band, non-contiguous, CA pair using a RF configuration using 8 RX chains. Referring to arrow F, in the operational state D, if the in-gap interference is low, the UE 110 may reduce the number of RF chains used to transition to a operational state shown in block E. Referring to block E, in this operational state, each RF chain may be used with a wider analogue filter to receive both intra-band, non-contiguous CCs for each MIMO layer, such that the number of RF chains may be reduced to 4. The freed up RF chains can be used for other purpose. Referring to arrow G, in the operational state E, if the in-gap interference increases above a threshold, the UE 110 may transition back to the operational state D.

FIG. 6B shows an example operational state transition according to the example embodiments of the present disclosure. Blocks A to E show example operational states for a pair of CCs and arrows F to Q show example conditions for performing the operational state transition. In the different operational states, or referred to as operational configurations, the hardware structure itself of the UE 110 may be identical. For example, the UE 110 may have one main module and three diversity modules, diversity module #1, diversity module #2, and diversity module #3, and each module has 2 RX chains. Each fragmented CC pair may be controlled individually and may correspond to a possibility of the operational state transition, so FIG. 6B may be a per band diagram.

In operational state A, up to 2 layer (2L) MIMO is used. 1 RX chain is configured with a wider analogue filter for the main module and diversity module #1, and each used RX chain is for receiving the pair of CCs. The other RX chain at the main module and diversity module #1 is deactivated. If in operational state A, the measured quality is sufficiently good, but the in-gap interference becomes high, referring to arrow O, the UE 110 may transition to operational state B where no wider analogue filter is used, diversity reception is not used, and 2 RX chains are used. If in operational state B, the measured quality is sufficiently good, and the in-gap interference becomes low, referring to arrow N, the UE 110 may transition to operational state A.

If in operational state A, the measured quality becomes low, and the in-gap interference becomes high, referring to arrow M, the UE 110 may transition to operational state C where 2L MIMO is supported, 2 RX chains for the main module and diversity module #1 are used, and no wider analogue filter is used. Each used RX chain is for receiving one CC. If in operational state C, the in-gap interference becomes low, referring to arrow L, the UE 110 may transition to operational state A.

If in operational state B, the measured quality becomes low, and the in-gap interference is high, referring to arrow P, the UE 110 may transition to operational state C. If in operational state C, the measured quality becomes sufficiently good, but the in-gap interference is high, referring to arrow Q, the UE 110 may transition to operational state B.

If in operational state C, the UE has more than 2 antennas, the MIMO rank can be increased, referring to arrow H, the UE 110 may transition to operational state D where 4 antennas allow up to 4 layer (4L) MIMO. 2 RX chains for the main module and three diversity modules are used, and each RX chain is used with a narrow analogue filter. Totally 2 RX chains are used across the 4 antennas, and each used RX chain is for receiving one CC. If in operational state D, the MIMO rank is reduced, referring to arrow I, the UE 110 may transition to operational state C releasing 2 antennas.

If in operational state D, the in-gap interference becomes low, referring to arrow F, the UE 110 may transition to operational state E where 4 antennas serve up to 4L MIMO. In operational state E, one RX chain is used for the main module and three diversity modules with a wider analogue filter, and the RX chain is for receiving the pair of CCs. Thus, totally 1 RX chain is used, and the other RX chains may be deactivated and can be used for other purposes. If in operational state E, the in-gap interference becomes high, referring to arrow G, the UE 110 may transition to operational state D.

If in operational state A where MIMO rank is up to 2, the MIMO rank is increased, referring to arrow J, the UE 110 may transition to operational state E where MIMO rank 4 is supported. If in operational state E, the MIMO rank is reduced freeing up antennas, referring to arrow K, the UE 110 may transition to operational state A. Compared to operational state E, in operational state A more RX chains may be deactivated and can be used for other purposes, as they are no longer used at the free antennas.

Referring back to FIG. 1A, in some embodiments, the configuration 140 of the transition between the multiple operational states may comprise a configuration for an operational state transition from a fifth operational state to a sixth operational state, and wherein in response to in-gap interference being lower than a threshold, the sixth operational state may have reduced number of RF chains in a same carrier than the fifth operational state; and the sixth operational state may utilize the second analog filter which has wider bandwidth than the fifth operational state.

In this case, in an operation 142, the UE 110 may transition from the fifth operational state to the sixth operational state. In the sixth operational state, the UE 110 may utilize the second analog filter to receive both intra-band, non-contiguous component carriers for at least one MIMO layer.

In some embodiments, the configuration 140 of the transition between the multiple operational states may comprise a configuration for an operational state transition from the sixth operational state to the fifth operational state, in response to in-gap interferer being above than a threshold. In this case, in an operation 144, the UE 110 may transition from the sixth operational state to the fifth operational state.

In some embodiments, the fifth operational state comprises 4 MIMO layers, 1 RX chain, and the second analog filter bandwidth with wider bandwidth than the first analog filter bandwidth; the sixth operational state comprises 4 MIMO layer, 2RX chains, and the first analog filter bandwidth with narrower bandwidth than the second analog filter bandwidth.

In some embodiments, the operational state D in FIG. 6A and FIG. 6B may be an example of the fifth operational state, and the operational state E in FIG. 6A and FIG. 6B may be an example of the sixth operational state.

In some embodiments, the configuration 140 of the transition between the multiple operational states may comprise a configuration for an operational state transition from a sixth operational state to a seventh operational state, wherein a second analog filter with a wider bandwidth can be used for both of the sixth operational state and the seventh operational state, and wherein a number of MIMO rank in the seventh operational state is capable of being decreased compared to a number of MIMO rank in the sixth operational state.

In this case, in an operation 146, the UE 110 may transition from the sixth operational state to the seventh operational state. In the seventh operational state, the decreased number of MIMO rank may deactivate at least one RF chain, and wherein the deactivated RF chain may be used for at least either adding inter-band combinations or increasing fragments in fragmented carrier aggregation band.

In some embodiments, the configuration 140 of the transition between the multiple operational states may comprise a configuration for an operational state transition from the seventh operational state to the sixth operational state. In this case, in an operation 148, the UE 110 may transition from the seventh operational state to the sixth operational state.

In some embodiments, the sixth operational state comprises 4 MIMO layers, 1 RX chain, and the second analog filter bandwidth with wider bandwidth than the first analog filter bandwidth; the seventh operational state comprises 2 MIMO layer with diversity, 2RX chains, and the second analog filter bandwidth with wider bandwidth than the first analog filter bandwidth.

In some embodiments, the operational state A in FIG. 6B may be an example of the seventh operational state, and the operational state E in FIG. 6B may be an example of the sixth operational state.

Table 2 shows an example of different configurations for the bands, e.g. n7, n25 and n66, for fragmented carriers.

TABLE 2

| | |
|---|---|
| CA_n7A-n25A-n66A | 4 + 4 + 4 |
| CA_n7A-n25A-n66A | 4 + 4 + 2 |
| | 1 spare RX chain |
| CA_n5A-n7A-n25A-n66A | 2 + 4 + 4 + 2 |
| | RX chain spent on inter-band CC |
| CA_n5A-n7A-n25A-n66(2A1) | 2 + 4 + 4 + 2 + 2 |
| | Fragmented CA support enabled on n66 |
| | using wider channel filter |

FIG. 1B shows an example sequence diagram according to the example embodiments of the present disclosure. The example sequence shown in FIG. 1 may be performed by the UE 110 and the network device 150. The network device 150 may function as radio access network (RAN).

Referring to FIG. 1B, at 1, UE 110 may transmit UE capability information to the network device 150. The UE capability information may comprise band combinations the UE 110 can support and fragmented carriers the UE 110 can support on the band combinations.

At 2, the UE 110 and the network device 150 may establish an initial CA configuration. At 3, the network device 150 may transmit to the UE 110 an RRC reconfiguration message, which may comprise, for example, the configurations of 3 CCs on n7, n25, and n66, respectively. Then, at 4, the UE 110 may transmit to the network device 150 an RRC reconfiguration complete message.

At 5, the network device 150 may transmit to the UE 110, for example, an MAC CE to activate the configured CCs. At 6, the CA configuration of the UE 110 may be denoted as CA_n7A-n25A-n66A, 4+4+4 layer MIMO, which is the first row of Table 2. The operational state may be that shown in FIG. 2A and FIG. 2B.

At 7, as normal for a CC configuration, the UE 110 may perform measurement on the CCs for quality, etc. The CC measurements may be a continuous operation, which is shown at 8. At 9, the UE 110 may transmit to the network device 150 an RI and may indicate to the network device 150 that, for example, the quality of the CCs is good.

At 10, for example, the network device 150 may decide to save radio resources on one CC, e.g. the CC on n66, and thus may downgrade the connections to 2L MIMO or diversity. So at 11, the network device 150 may transmit to the UE 110 an RRC reconfiguration message comprising, for example, the configurations of 3 CCs on n7, n25, and n66, respectively, in which n66 is downgraded to 2L MIMO. In addition, the network device 150 may configure a 2L MIMO carrier on band n5A. Then, at 12, the UE 110 may transmit to the network device 150 an RRC reconfiguration complete message.

At 13, the CA configuration of the UE 110 may be denoted as CA_n7A-n25A-n66A, 4+4+2 layer MIMO, which is the second row of Table 2. The operational state may be that shown in FIG. 3A and FIG. 3B.

At 14, the UE 110 may perform measurements on the CCs for quality, etc. If at 15, for example, the measurement result allows for the activation of the carrier on band n5A, at 16, the network device 150 may transmit to the UE 110, for example, an MAC CE to activate the configured CC on band n5A. Currently, at 17, the CA configuration of the UE 110 may be denoted as CA_n5A-n7A-n25A-n66A, 2+4+4+2 layer MIMO, which is the third row of Table 2. The operational state may be that shown in FIG. 4A and FIG. 4B. At 18, the UE 110 may perform measurement on the CCs for quality, etc.

At 19, for example, if the UE capabilities allow for fragmented carriers on band n66A, the network device 150 may decide to enable a fragmented carrier for n66A by adding a non-continuous intra-band carrier on top of the CC already configured for band n66A.

So, at 20, the network device 150 may transmit to the ULE 110 an RRC reconfiguration message comprising the addition of a non-continuous intra-band carrier on band n66A. At 21, the UE 110 may transmit to the network device 150 an RRC reconfiguration complete message.

At 22, the UE 110 may perform measurements on the CCs, e.g., interference on band n66A, and at 23 may transmit to the network device 150 a measurement report comprising the in-gap interferer on band n66A.

If the in-gap interference on band n66A is low, at 24, the network device 150 may transmit to the UE 110, for example, an MAC CE to activate the added fragmented CC on band n66A. Currently, at 25, the CA configuration of the UE 110 may be denoted as CA_n5A-n7A-n25A-n66(2A1), 2+4+4+2+2 layer MIMO, which is the fourth row of Table 2. The operational state may be that shown in FIG. 5A and FIG. 5B, in which one RF chain is configured for receiving a wider bandwidth comprising both fragmented CCs on n66A.

Further, the operation could continue to enable 4L MIMO fragmented carriers on both n7 and 25 as well, if in-gap interference on those bands allows for it. And the operation could also proceed to remove the carrier on band n5 again and upgrade the n66 band carrier pair to 4L MIMO, i.e. operational state E shown in FIG. 6A and FIG. 6B via operational state D.

In some embodiments, the option to change to fragmented carrier support can be done without an RRC signaling, if the additional fragmented carrier has already been configured. In this case, the additional fragmented carrier can be activated and/or received automatically by the UE 110 without the RRC signaling, and an MAC signaling is sufficient. This means that the RRC reconfiguration at 20 can be avoided and that the UE 110 could be the initiator of the activation of the additional fragmented carrier at 24.

In some example embodiments, the UE 110 may apply different number of RX antennas to the carrier aggregation combination. The UE 110 may send the supported states of antennas in the UE capability reporting upon registration, which means that transitions between the states depend on radio resource configurations from the network. The network can choose between the operational states based on the reported interference level, and the network may reconfigure the UE 110 to transition between the operational states that determine the number of used RX antennas and the purpose of the freed up RX chains.

FIG. 1C shows an example sequence diagram according to the example embodiments of the present disclosure. The example sequence shown in FIG. 1B may be performed by the UE 110 and the network device 150.

Referring to FIG. 1C, in an operation 130, the UE 110 may receive a CA configuration comprising at least one combination of CCs. In some embodiments, the CA configuration may comprise multiple combination of CCs the UE 110 supports.

In some embodiments, if in an operation 180 it is the network device 150 that transmits to the UE 110, the configured combination of CCs, the UE 110 may determine to use the combination of CCs configured from the network. The combination of CCs may be configured by the network device 150 and/or other network device.

In some embodiments, the UE 110 may be configured to support the multiple operational states of a same activation of hardware to support different levels of CA based on at least one of the followings: presence of in-gap interference; inter-band combination demand; number of connectable RX antennas; or actual MIMO rank. The same activation of hardware may refer to the same hardware structure. The levels of CA may involve the CCs the UE 110 can simultaneously support, which may comprise the case where the periods for the CCs are aligned and also the case where the periods for the CCs partly overlap.

In an operation 132, in response to receiving the CA configuration, the UE 110 may determine an operational state for receiving a configured combination of CCs from the at least one combination of CCs in the received CA configuration. In some embodiments, the UE 110 may determine the operational state for the combination of CCs using at least one of the following conditions: presence of in-gap interference, inter-band combination demand, a number of connectable receive antennas, or an actual MIMO rank. In some embodiments, the operational state may be used to determine at least one of: a number of activated RX antennas or a number of RX chains.

In some embodiments, the operational state may be a combination of at least one of: a number of MIMO layers, a number of RX chains, and analog filter bandwidth. In some embodiments, the number of MIMO layers may be more than one, e.g., 2 layers or 4 layers; the number of RX chains may comprise at least one of: 1 RX chain, 2 RX chains per MIMO layer; and the analog filter bandwidth may comprise: either a first analog filter bandwidth, or a second analog filter bandwidth, and the first analog bandwidth is narrower than the second analog bandwidth.

In some embodiments, in an operation 134, the UE 110 may select antennas based on receiving quality of the antennas with respect to the configured combination of CCs and determine the operational state by the selection of antennas. Further, in some embodiments, in an operation 136, the UE 110 may map the antennas to the CCs based on receiving performance.

In some embodiments, the number of the RX chains for a same carrier may be determined based on a receive condition at the UE 110, wherein poorer receive condition demands larger number of RX chains, and better receive condition relaxes the number of RX chains. That is, for a CC if the receive condition is good, less number, e.g. 2 of RX chains may be sufficient. On the contrary. if the receive condition is bad, more RX chains, e.g. 4 RX chains, may be required.

In some embodiments, when the receive condition is above a threshold, the UE 110 may deactivate at least one RX chain of the same carrier, and the deactivated at least one RX chain may be used as spare RX chain.

In some embodiments, the at least one spare RX chain may be used for at least one of: increasing inter-band combinations or increasing fragments in fragmented carrier aggregation band of the band combinations.

In some the ULE 110 may determine an operational state to use a second number, reduced from a first number, of active antennas for respective non-contiguous intra-band CCs, where an active antenna of the second number of active antennas is used for one CC, and the UE 110 may deactivate a third number of antennas, within the first number of antennas, beyond the second number of antennas.

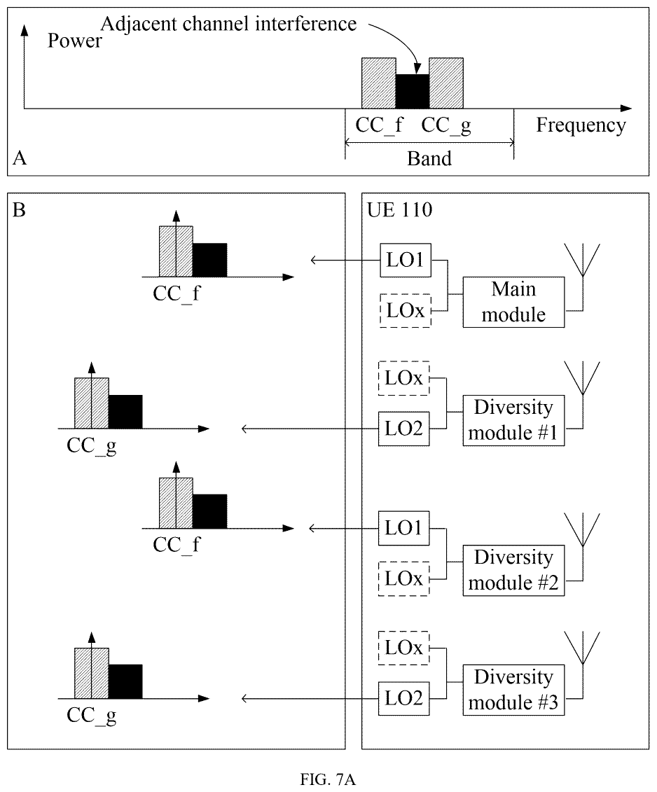

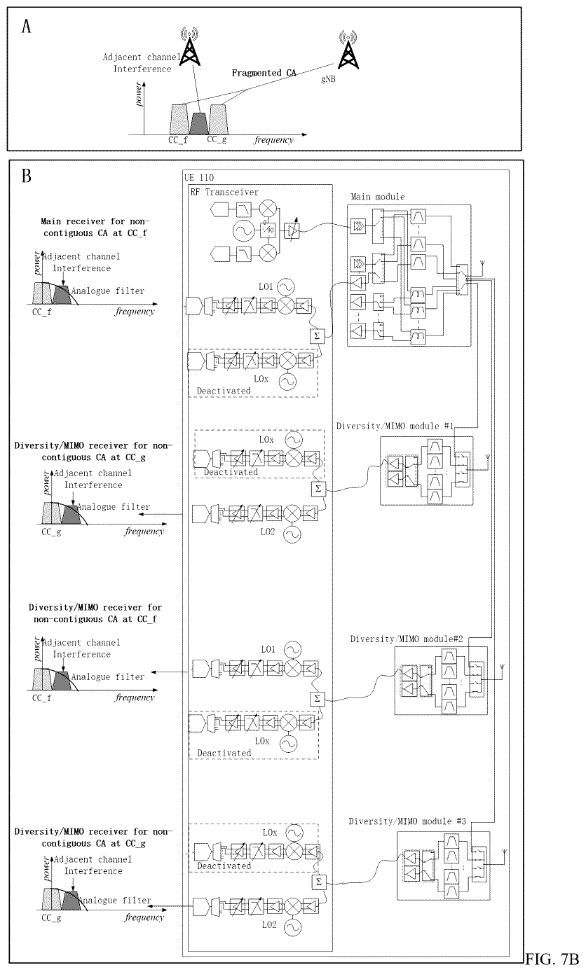

FIG. 7A shows an example operational state according to the example embodiments of the present disclosure. FIG. 7B shows an example operational state with example diagram corresponding to FIG. 7A. Referring to FIG. 7A and FIG. 7B, block A shows an example of DL signal input into the antennas of the UE 110, the block of the UE 110 shows an example of the operational state, and block B shows an example of the DL signal processed by the UE 110. And FIG. 7B further shows in RF transceiver each LO is associated with an RX chain, as well as a gNB serving the UE 110 and adjacent channel interference caused by other gNB(s).

Referring to block A, the used combination of CCs may comprise non-contiguous intra-band CC_f and CC_g with adjacent channel interference. The band may be, for example, n25.

The antenna modules of the UE 110 may comprise a main module and three diversity modules. The main module may be, for example, a front-end module, and the three diversity modules may be denoted as diversity module #1, diversity module #2, and diversity module #3. Each of the modules may use two LOs, denoted as LO1 and LO2.

The UE 110 may downgrade/downscale the antenna use and the supported MIMO rank for CC_f and CC_g from 4 to 2. operational The UE 110 may use two, reduced from four, active antennas for CC_f and CC_g, where an active antenna of the second number of active antennas may be used for one CC of CC_f and CC_g. In this case, the first number=4, and the second number=2. For example, the UE 110 may use LO1 at the main module and diversity module #2 for CC_f and LO2 at diversity module #1 and diversity module #3 for CC_g, and the UE 110 may also use an analogue filter in each active RX chain to suppress the adjacent channel interference caused by an in-gap interferer.

Thus, the UE 110 may select an antenna receive path for a CC based on receiving performance, e.g. receiver qualities. FIG. 7A and FIG. 7B show an example of (1, 2, 1, 2), which represent which of LO1 and LO2 at the main module, diversity module #1, diversity module #2, and diversity module #3 are selected. If other mapping of the antennas to the CCs may provide better receiver qualities, the UE 110 may map the antennas to the CCs according to (1,1,2,2), (2,1,2,1), etc. based on the receiving performance. The antenna selection in the example embodiments of the present disclosure may focus on the mapping of antennas to CCs.

In the example operational state shown in FIG. 7A and FIG. 7B, the UE 110 may deactivate two antennas for respective CCs. In this case, third number=2. As shown in FIG. 7A and FIG. 7B, the UE 110 may deactivate LOx at the main module, diversity module #1, diversity module #2, and diversity module #3. LOx may represent any LO other than the used LO at the modules. Thus, for CC_f the antennas of diversity module #1 and diversity module #3 are deactivated, and for CC_g the antennas of the main module and diversity module #2 are deactivated.

In the example operational state shown in FIG. 7A and FIG. 7B, CC_f and CC_g each uses two antenna paths, bringing the number of DL streams from 4 to 2 (MIMO rank from 4 to 2), and the UE 110 can still be compliant to 3rd Generation Partnership Project (3GPP) standard which requires at least two antennas to be supported. For bands such as n25 and n66, two receive antennas are required. According to the example embodiments of the present disclosure, a UE with more receive antennas than required may downscale the MIMO rank (active antennas) to support fragmented CA and remain the receiving performance at the minimum two receive antennas, and the deactivated antennas (deactivated RX chain) can be used for other purpose.

In some embodiments, the UE 110 may determine an operational state to use a second number, reduced from a first number, of active RX chains at respective antennas for non-contiguous intra-band CCs, where one active RX chain at the respective antennas is used for the CCs utilizing a wider analogue filter on the band, and the UE 110 may deactivate a third number of RX chains at the respective antennas, within the first number of RX chains at the respective antennas, beyond the second number.

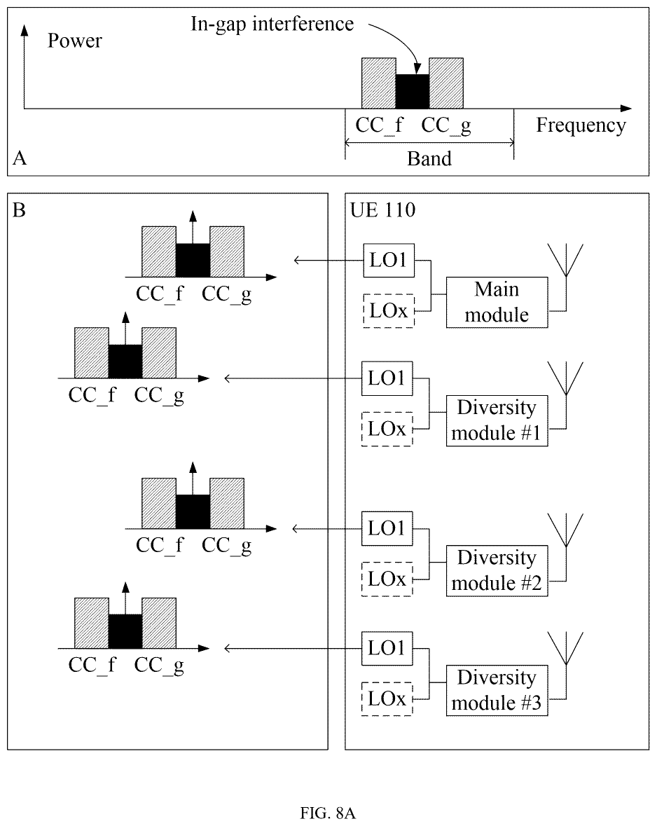

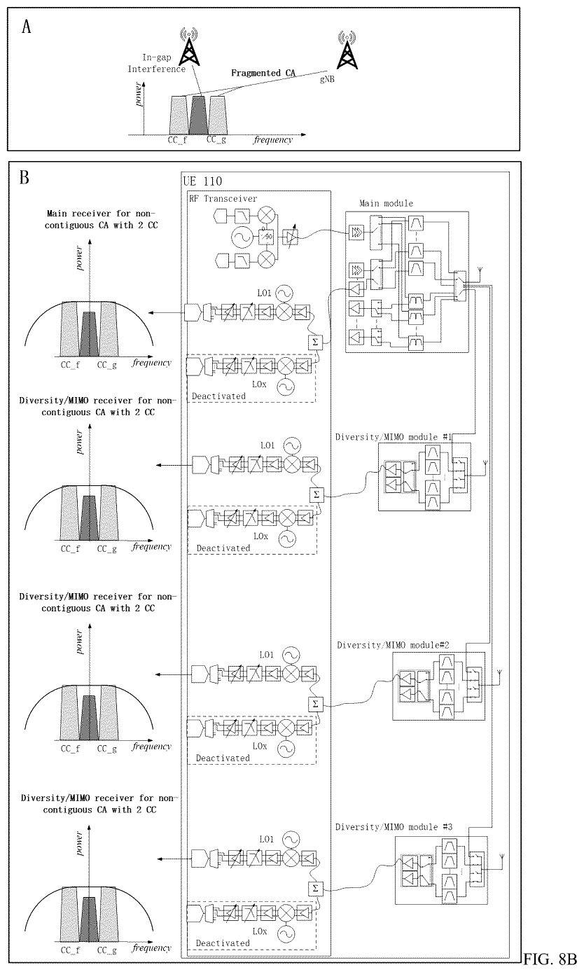

FIG. 8A shows an example operational state according to the example embodiments of the present disclosure. FIG. 8B shows an example operational state with example diagram corresponding to FIG. 8A. Referring to FIG. 8A and FIG. 8B, block A shows an example of DL signal input into the antennas of the UE 110, the block of the UE 110 shows an example of the hardware state, and block B shows an example of the DL signal processed by the UE 110. And FIG. 8B further shows in RF transceiver each LO is associated with an RX chain, as well as a gNB serving the UE 110 and in-gap interference caused by other gNB(s).

Referring to block A, the DL signal may be the same as that in FIG. 7A and FIG. 7B. The hardware structure itself of the UE 110 may be the same as that in FIG. 7A and FIG. 7B.

In the example operational state shown in FIG. 8A and FIG. 8B, the UE 110 may use 1 RX chain at the respective antennas for CC_f and CC_g, where one active RX chain uses LO1 at the main module, diversity module #1, diversity module #2, and diversity module #3 for CC_f and CC_g utilizing a wider analogue filter on the band. In this case, the first number=2, and the second number=1.

Similar to the example embodiments described with respect to FIG. 7A and FIG. 7B, the UE 110 may map the antennas to the CCs based on receiving performance. For example, the UE 110 may select LO2 instead of LO1 at the main module, diversity module #1, diversity module #2, and/or diversity module #3 for CC_f and CC_g, and LO1 can be used for other purpose.

In the example operational state shown in FIG. 8A and FIG. 8B, the UE 110 may deactivate the RX chain of LOx at the main module, diversity module #1, diversity module #2, and diversity module #3. LOx may represent any LO other than the used LO1 at the modules. Thus, when the UE 110 uses one RX chain for receiving the fragmented carriers utilizing the wider analogue filter, 1 RX chain can be deactivated for other purpose. In this case, the third number=1.

In some embodiments, the UE 110 may determine an operational state to use a first number of active antennas for CCs on bands comprising at least a first band and a second band, where an active antenna of the first number of active antennas is used for the CCs on the first band and the second band utilizing wider analogue filters on the first band and the second band.

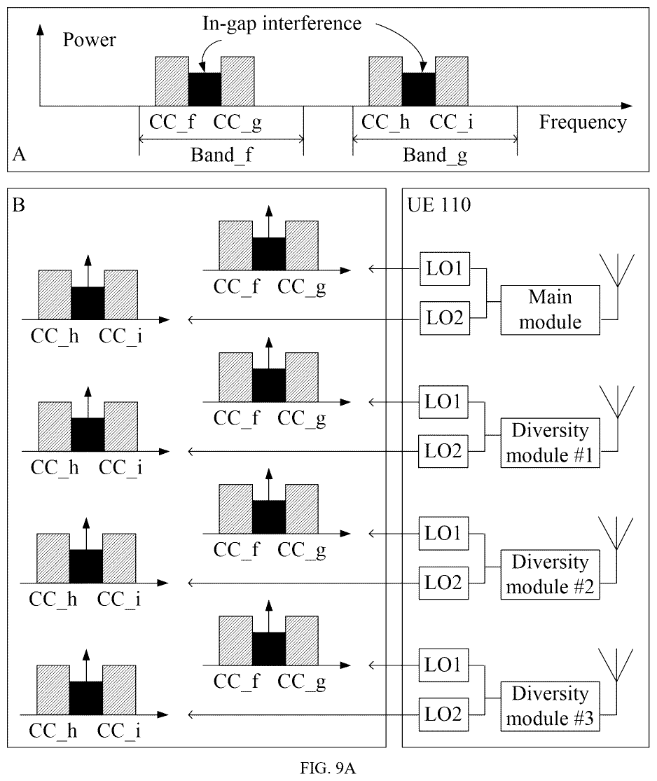

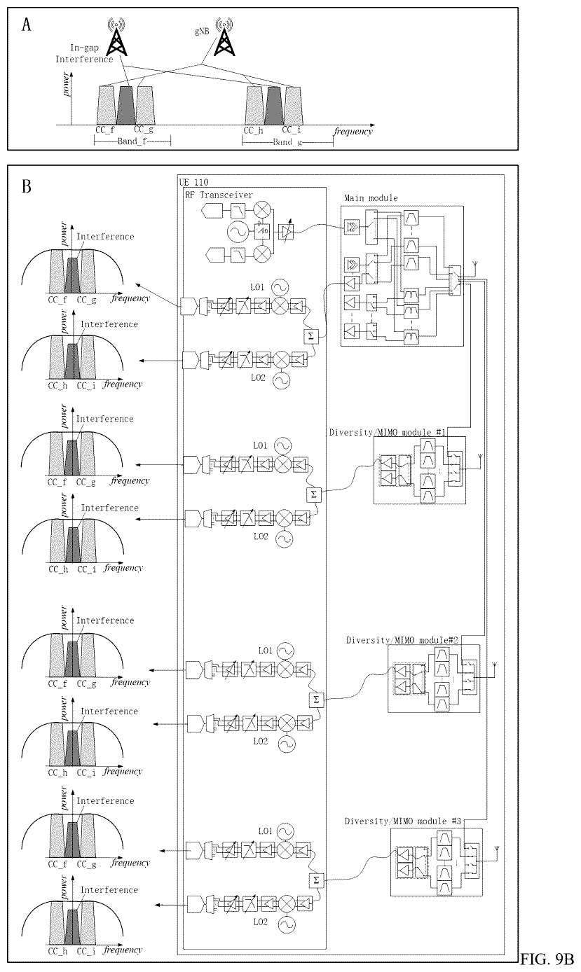

FIG. 9A shows an example operational state according to the example embodiments of the present disclosure. FIG. 9B shows an example operational state with example diagram corresponding to FIG. 9A. Referring to FIG. 9A and FIG. 9B, block A shows an example of DL signal input into the antennas of the UE 110, the block of the UE 110 shows an example of the operational state, and block B shows an example of the DL signal processed by the UE 110. And FIG. 9B further shows in RF transceiver each LO is associated with an RX chain, as well as a gNB serving the UE 110 and in-gap interference caused by other gNB(s).

Referring to block A, the DL signal comprise CC_f and CC_g on band_f and CC_h and CC_i on band_g. Band_f may be, the first band, for example, n25, and band_g may be the second band, for example, n66. The network device 150 has fragmented CAs in both band_f and band_g, and other BS(s) may cause in-gap interference in both band_f and band_g. The hardware structure itself of the UE 110 may be the same as that in FIG. 7A and FIG. 7B or FIG. 8A and FIG. 8B.

In the example operational state shown in FIG. 9A and FIG. 9B, the first number equals to four, and each active antenna of the four active antennas is used for CC_f and CC_g on band_f and CC_h and CC_i on band_g utilizing wider analogue filters on band_f and band_g. The deactivated RX chains in the hardware state shown in FIG. 8A and FIG. 8B may be used for CC_h and CC_i on band_g. The RX chain of LO1 applies the wider analogue filter for CC_f and CC_g on band_f using LO1 for frequency alignment in band_f, while the RX chain of LO2 applies the wider analogue filter for CC_h and CC_i on band_g using LO2 for frequency alignment in band_g.

Similar to the example embodiments described with respect to FIG. 7A and FIG. 7B, the UE 110 may map the antennas to the CCs based on receiving performance. Those skilled in the art may understand that the RX chain of LO1 may also be used for CC_h and CC_i on band_g, and the RX chain of LO2 may also be used for CC_f and CC_g on band_f.

Thus, the example embodiments of the present disclosure can support rank 4 DL MIMO on inter-band CA of non-contiguous intra-band carriers using the wider analogue filters, where the UE 110 may use the operational state shown in FIG. 9A and FIG. 9B to support inter-band CA with fragmented carriers rather than single band operation.

In some embodiments, the UE 110 may determine a operational state to use a first number of active antennas for CCs on bands comprising at least a first band and a second band, where an active antenna of a second number, reduced from the first number, of active antennas is used for the CCs on the first band utilizing a wider analogue filter on the first band, and an active antenna of a third number, reduced from the first number, of active antennas is used for the CCs on the second band utilizing a wider analogue filter on the second band.

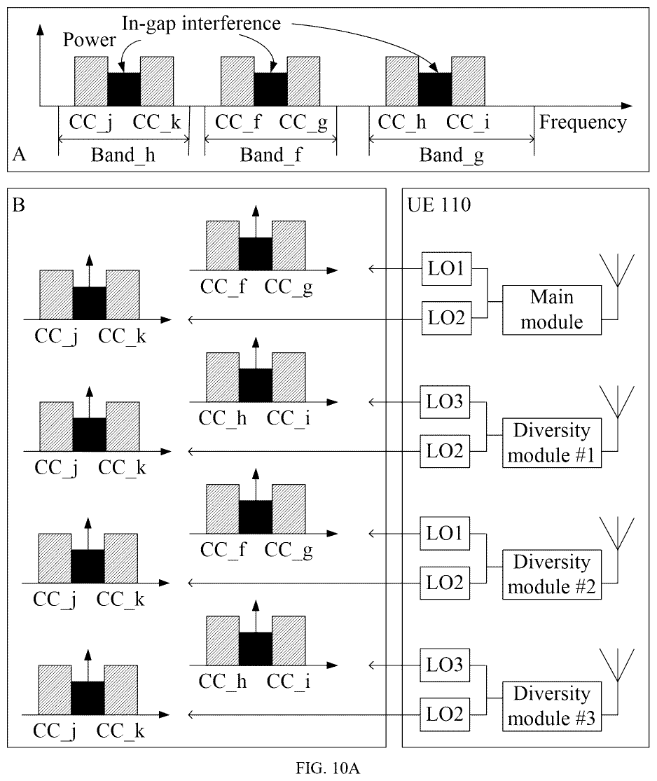

FIG. 10A shows an example operational state according to the example embodiments of the present disclosure. FIG. 10B shows an example operational state with example diagram corresponding to FIG. 10A. Referring to FIG. 10A and FIG. 10B, block A shows an example of DL signal input into the antennas of the UE 110, the block of the UE 110 shows an example of the operational state, and block B shows an example of the DL signal processed by the UE 110. And FIG. 10B further shows in RF transceiver each LO is associated with an RX chain, as well as a gNB serving the UE 110 and in-gap interference caused by other gNB(s).

Referring to block A, the DL signal comprises at least CC_f and CC_g on band_f and CC_h and CC_i on band_g. Band_f may be, the first band, for example, n25, and band_g may be the second band, for example, n66. There is in-gap interference in both band_f and band_g. The hardware structure itself of the UE 110 may be the same as that in FIG. 7A and FIG. 7B, FIG. 8A and FIG. 8B or FIG. 9A and FIG. 9B.

In the example operational state shown in FIG. 10A and FIG. 10B, two active antennas, for example, the RX chains of LO1, at the main module and diversity module #2 are used for CC_f and CC_g on band_f utilizing a wider analogue filter on band_f, and two active antennas, for example, the RX chains of LO3, at diversity module #1 and diversity module #3 are used for CC_h and CC_i on band_g utilizing a wider analogue filter on band_g. In this case, the first number=4, the second number=2, and the third number=2.

Thus, by downgrading the MIMO rank for band_f and band_g from 4 to 2, more RX chains, at the main module, diversity module #1, diversity module #2, and diversity module #3, are available, which in turn allows higher inter-band CA support.

Compared to the example operational state shown in FIG. 9A and FIG. 9B, the UE 110 reduces the number of antennas available on the two inter-bands, band_f and band_g, to make space for even a third band as an inter-band additional carrier. In the example operational state shown in FIG. 10A and FIG. 10B, the CCs may further comprise CC_j and CC_k on band_h. Band_h may be, the third band, for example, n7. In some embodiments, the UE 110 may use a fourth number of antennas, within the first number of antennas for the CCs on the third band where an active antenna of the fourth number of active antennas is used for the CCs on the third band utilizing a wider analogue filter on the third band.

In the example operational state shown in FIG. 10A and FIG. 10B, four antennas at the main module, diversity module #1, diversity module #2, and diversity module #3 are used for CC_j and CC_k on band_h utilizing the wider analogue filter on band_h. In this case, the fourth number=4.

Similar to the example embodiments described with respect to FIG. 7A and FIG. 7B, the UE 110 may map the antennas to the CCs based on receiving performance. For example, the UE 110 may select LO2 instead of LO1 or LO3 at the main module, diversity module #1, diversity module #2, and/or diversity module #3 for band_f and band_g, and LO1 or LO3 can be used for band_h. The UE 110 can arbitrarily assign the RX chains for the inter-bands CCs.

In case the network device 150 may serve three fragmented bands, for example, band_f, band_g, and band_h shown in FIG. 10A and FIG. 10B, the UE 110 may still use 4 antennas the same as the 4 antennas shown in FIG. 7A and FIG. 7B, FIG. 8A and FIG. 8B, or FIG. 9A and FIG. 9B, to support the two CCs in each band. CC_f and CC_g may be received by 2 antennas using wider analogue filters, CC_h and CC_i may be received by 2 antennas using wider analogue filters, and CC_j and CC_k may be received by 4 antennas using wider analogue filters. In the example operational state shown in FIG. 10A and FIG. 10B, 3 inter-bands can be received by 4 antennas, and thus the CA combination can be increased to support NC IB CA in three inter-bands, e.g., n7, n25, and n66.

In case the UE 110 maps the antennas to the CCs based on receiving performance, the UE 110 may prioritize the antenna assignments based on locations of primary carrier component (PCC) and secondary carrier component (SCC) and/or throughputs at CCs. The UE 110 may convert the supported MIMO layers for bands from CA_n7A-n25A-n66A to CA_n7(2A)-n25(2A)-n66(2A), which means the DL MIMO rank on the two bands, e.g., n25 and n66, may be lowered. The UE 110 may declare the DL MIMO layer as 4+4+2+2+2+2=16.

The example embodiments can also increase the number of supported fragmented component carrier pairs and thereby the number of such state machines supported. Ideally, the RF chains should be mappable to any antenna/band and thereby the example shown in FIG. 10A and FIG. 10B could support up to 4 fragmented component carrier pairs with RX paths for each.

The example embodiments of the present disclosure can apply in the case that the inter-band fragmented CC pairs are co-located or not co-located.

The example embodiments of the present disclosure can apply in the case of smartphone. In the example embodiments of the present disclosure, the UE 110 may be a smartphone device.

According to the example embodiments of the present disclosure, a UE can transition between operational states/configurations comprising different analogue filters to support fragmented CA and may transition between operational states/configurations of different antenna paths/routings.

In addition, according to the example embodiments of the present disclosure, a UE can compromise in MIMO capabilities of fragmented CCs to support more carriers and may be configured to transition among multiple operational states/configurations of the same hardware structure to support different numbers of configured CCs.

Further, according to the example embodiments of the present disclosure, a UE can map RX antennas to CCs based on receiving performance, such that the UE can optimize receiving conditions with respect to priority of the CCs.

According to the example embodiments of the present disclosure, a network may be aware of a UE's capability to support multiple operational states, and thus the network can apply and configure inter-band CA based on the UE information on operational configurability. In addition, according to the example embodiments of the present disclosure, a network may apply state transitions which can serve a UE optimization in terms of carrier configuration across multiple bands of operation available to an operator that holds fragmented spectrum.

According to the example embodiments of the present disclosure, a UE may transition to different operational states/configurations, without a change in the hardware structure, to support much more different and advanced CA configurations that allow much higher throughputs in fragmented spectrum bands, and the UE can flexibly transition between operational states based on different receiver performances and balance the aspects of both used RX antennas and carrier interference suppression (for example, by selecting width of analogue filter).

According to the example embodiments of the present disclosure, the usage of wider analogue filter can allow more CCs to be received by more antennas, e.g. 4 antennas, which can improve receiver quality for the CCs, if the in-gap interference is low. On the other hand, if the number of antennas for receiving a CC is reduced, e.g. from 4 to 2, for example for CC_f and CC_g in FIG. 7A and FIG. 7B this configuration may be resilient to the in-gap interference, and deactivated antennas can be used for other purposes.

According to the example embodiments of the present disclosure, the usage of wider analogue filter can also increase the number of supported fragmented CC pairs. For example, the operational state shown in FIG. 10A and FIG. 10B could support up to 4 fragmented CC pairs by using the RX chains of LO2 at diversity module #1 and diversity module #3 for another pair of CCs.

FIG. 11 shows a flow chart illustrating an example method 1100 according to the example embodiments of the present disclosure. The example method 1100 may be performed, for example, by an apparatus for a terminal device, such as the UE 110 above mentioned.

Referring to FIG. 11, the example method 1100 may comprise: an operation 1110 of transmitting, to a network node, capabilities of the apparatus comprising at least one of band combinations supported by the apparatus, fragmented carriers supported by the apparatus, and multiple operational states supported by the apparatus associated with MIMO reception across multiple antennas that enable multiple MIMO layers; and an operation 1120 of receiving, from the network node, a configuration of a transition between the multiple operational states; wherein one operational state of the multiple operational states is used to determine at least one of: a number of activated RX antennas or a number of RX chains.

In some embodiments, the one operational state of the multiple operational states may be a combination of at least one of: a number of MIMO layers, a number of RX chains, and analog filter bandwidth.

In some embodiments, the number of MIMO layers may be more than one; the number of RX chains may comprise at least one of: 1 RX chain, 2 RX chains per MIMO layer; and the analog filter bandwidth may comprise: either a first analog filter bandwidth, or a second analog filter bandwidth, and the first analog bandwidth is narrower than the second analog bandwidth.

In some embodiments, the number of the RX chains for a same carrier may be determined based on a receive condition at the apparatus, wherein poorer receive condition may demand larger number of RX chains, and better receive condition may relaxe number of RX chains.

In some embodiments, the example method 1100 may comprise: relaxing at least one RX chain of the same carrier when the receive condition is above a threshold, and the relaxed at least one RX chain may be used as spare RX chain.

In some embodiments, the at least one spare RX chain may be used for at least one of: increasing inter-band combinations or increasing fragments in fragmented carrier aggregation band of the band combinations.

In some embodiments, the configuration of the transition between the multiple operational states may comprise a configuration for an operational state transition from one operational state to another operational state, and wherein in response to in-gap interference being lower than a threshold, the another operational state has reduced number of RF chains in a same carrier than the one operational state; the another operational state utilizes the second analog filter which has wider bandwidth than the one operational state.

In some embodiments, the second analog filter which has the wider bandwidth filter may be used to receive both intra-band, non-contiguous component carriers for at least one MIMO layer.

In some embodiments, the configuration of the transition between the multiple operational states may comprise a configuration for an operational state transition from the another operational state to the one operational state, in response to in-gap interferer being above a threshold.

In some embodiments, the one operational state may comprise 4 MIMO layers, 1 RX chain, and the second analog filter bandwidth with wider bandwidth than the first analog filter bandwidth; the another operational state may comprise 4 MIMO layer, 2RX chains, and the first analog filter bandwidth with narrower bandwidth than the second analog filter bandwidth.

In some embodiments, the configuration of the transition between the multiple operational states may comprises a configuration for an operational state transition from one operational state to another operational state, wherein a second analog filter with a wider bandwidth can be used for both of the one operational state and the another operational state, and wherein a number of MIMO rank in the another operational state is capable of being decreased compared to a number of MIMO rank in the one operational state.

In some embodiments, the decreased number of MIMO rank in the another operational state may deactivate at least one RF chain, and wherein the deactivated RF chain is used for at least either adding inter-band combinations or increasing carriers in another fragmented carrier aggregation bands.

In some embodiments, the configuration of the transition between the multiple operational states may comprises a configuration for an operational state transition from the another operational state to the one operational state.

In some embodiments, the one operational state may comprise 4 MIMO layers, 1 RX chain, and the second analog filter bandwidth with wider bandwidth than the first analog filter bandwidth; the another operational state may comprise 2 MIMO layer with diversity, 2RX chains, and the second analog filter bandwidth with wider bandwidth than the first analog filter bandwidth.

In some embodiments, the example method 1100 may comprise: supporting the multiple operational states of a same activation of hardware to support different levels of carrier aggregation based on at least one of the followings: presence of in-gap interference; inter-band combination demand; number of connectable RX antennas; or actual MIMO rank.

In some embodiments, the configuration of the transition between the multiple operational states may comprise a first configuration for the apparatus to transition to or remain in a first operational state, the first configuration comprises multiple configured component carriers, on at least a first band of the band combinations, and in the first operational state, for a component carrier of the multiple configured component carriers, a first number of RX chains are activated.

In some embodiments, the multiple configured component carriers may comprise three component carriers with each one on three individual bands; on the respective bands, the number of MIMO layers is 4; the first number of the activated RX chains is 2, and the first analog filter bandwidth with narrower bandwidth than the second analog filter bandwidth is used for each of the activated RX chains.

In some embodiments, the configuration of the transition between the multiple operational states may comprise a second configuration for the apparatus to transition to or remain in a second operational state, the second configuration comprises the multiple configured component carriers, and in the second operational state, for a first component carrier of the multiple configured component carriers, a number, reduced from the first number, of RX chains is activated for the first component carrier and a number of RX chains beyond the reduced number are deactivated.

In some embodiments, the first component carrier may be on the first band, the multiple configured component carriers may be on the first band and two additional bands; on the respective two component carriers configured on the two additional band, the number of MIMO layers is 4; the first number of the activated RX chains is 2, and the first analog filter bandwidth with narrower bandwidth than the second analog filter bandwidth is used; on the first component carrier of the first band, the number of MIMO layers is 2; the number of the activated RX chains is 1, and the first analog filter bandwidth with narrower bandwidth than the second analog filter bandwidth is used.

In some embodiments, the configuration of the transition between the multiple operational states may comprise a third configuration for the apparatus to transition to or remain in a third operational state, the third configuration comprises a second component carrier on a band besides the band combinations of the three previously used bands, and in the third operational state, the deactivated RX chains are activated for the second component carrier.

In some embodiments, the second component carrier of the multiple configured component carriers is on a fourth band besides the band combinations of the three previously used bands; on the second component carrier on the fourth band of, the number of MIMO layers is 2; the number of the activated RX chains is 1, and the first analog filter bandwidth with narrower bandwidth than the second analog filter bandwidth is used; on respective two component carriers of the second and third bands, the number of MIMO layers is 4; the first number of the activated RX chains is 2, and the first analog filter bandwidth with narrower bandwidth than the second analog filter bandwidth is used; on the first component carrier of the first band, the number of MIMO layers is 2; the number of the activated RX chains is 1, and the first analog filter bandwidth with narrower bandwidth than the second analog filter bandwidth is used.

In some embodiments, the configuration of the transition between the multiple operational states comprises a fourth configuration for the apparatus to transition to or remain in a fourth operational state, the fourth configuration comprises a third component carrier on the first band, and in the fourth operational state, the first band having been configured to receive a fourth component carrier is reconfigured for receiving the third component carrier while also receiving the fourth component carrier, and a second analog filter which has wider bandwidth is used on the first band.

In some embodiments, the third component carrier and the fourth component carrier are both on the first band; on the fourth band, the number of MIMO layers is 2; the number of the activated RX chains is 1, and the first analog filter bandwidth with narrower bandwidth than the second analog filter bandwidth is used; on respective two component carriers of the second and third bands, the number of MIMO layers is 4; the first number of the activated RX chains is 2, and the first analog filter bandwidth with narrower bandwidth than the second analog filter bandwidth is used; on the respective one of the third and the fourth component carriers on the first band, the number of MIMO layers is 2; the number of the activated RX chains is 1, and the second analog filter bandwidth with wider bandwidth than the first analog filter bandwidth is used.

In some embodiments, the first band may be n66, the second band may be n7, the third band may be n25, and/or the fourth band may be n5.

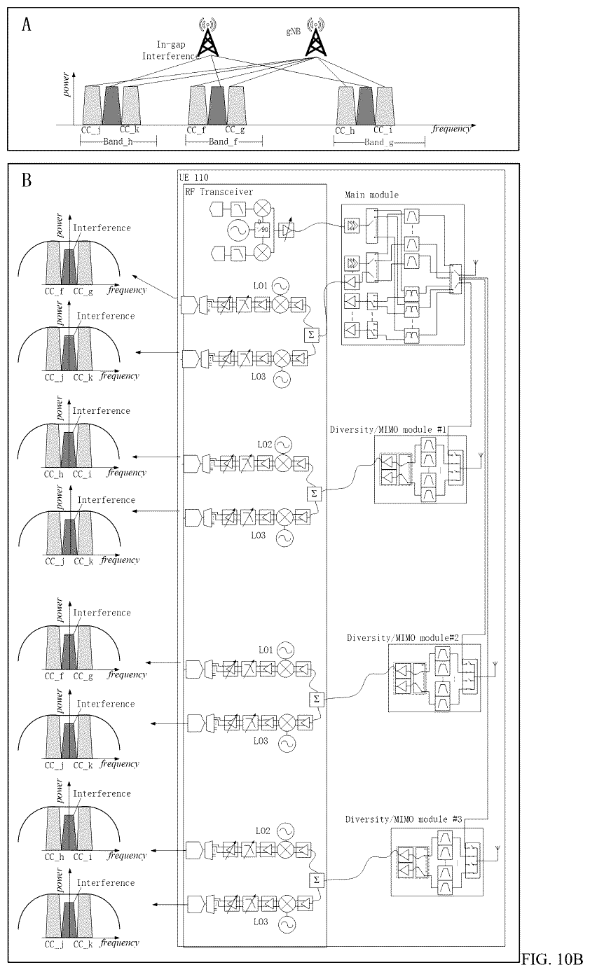

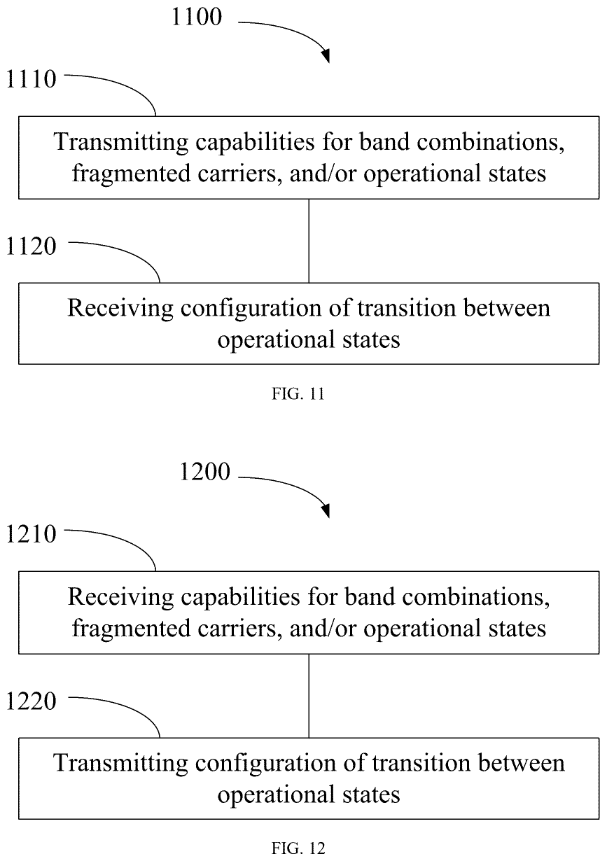

FIG. 12 shows a flow chart illustrating an example method 1200 according to the example embodiments of the present disclosure. The example method 1200 may be performed, for example, by an apparatus for a network device, such as the network device 150 above mentioned.

Referring to FIG. 12, the example method 1200 may comprise: an operation 1210 of receiving, from a terminal device, capabilities of the apparatus comprising at least one of band combinations supported by the terminal device, fragmented carriers supported by the terminal device, and multiple operational states supported by the terminal device associated with MIMO reception across multiple antennas that enable multiple MIMO layers; and an operation 1220 of transmitting, to the terminal device, a configuration comprising a transition between the multiple operational states, wherein one operational state of the multiple operational states is used to determine at least one of: a number of activated RX antennas or a number of RX chains.

In some embodiments, the one operational state of the multiple operational states may be a combination of at least one of: a number of MIMO layers, a number of RX chains, and analog filter bandwidth.

In some embodiments, the number of MIMO layers may be more than one; the number of RX chains may comprise at least one of: 1 RX chain, 2 RX chains per MIMO layer; and the analog filter bandwidth may comprise: either a first analog filter bandwidth, or a second analog filter bandwidth, and the first analog bandwidth is narrower than the second analog bandwidth.

In some embodiments, the number of the RX chains for a same carrier may be determined based on a receive condition at the terminal device, wherein poorer receive condition demands larger number of RX chains, and better receive condition relaxes the number of RX chains.

In some embodiments, the example method 1200 may comprise: determining to deactivate at least one RX chain of the same carrier when the receive condition is above a threshold, and the deactivated at least one RX chain is used as spare RX chain.

In some embodiments, the at least one spare RX chain may be used for at least one of: increasing inter-band combinations or increasing fragments in fragmented carrier aggregation bands of the band combinations.

In some embodiments, the configuration of the transition between the multiple operational states may comprise a configuration for an operational state transition from one operational state to another operational state, and wherein in response to in-gap interference being lower than a threshold, the another operational state has reduced number of RF chains in a same carrier than the one operational state; the another operational state utilizes the second analog filter which has wider bandwidth than the one operational state.

In some embodiments, the second analog filter which has the wider bandwidth filter may be used to receive both intra-band, non-contiguous component carriers for at least one MIMO layer.

In some embodiments, the configuration of the transition between the multiple operational states may comprise a configuration for an operational state transition from the another operational state to the one operational state, in response to in-gap interferer is being above than a threshold.

In some embodiments, the one operational state may comprise 4 MIMO layers, 1 RX chain, and the second analog filter bandwidth with wider bandwidth than the first analog filter bandwidth; the another operational state comprises 4 MIMO layer, 2RX chains, and the first analog filter bandwidth with narrower bandwidth than the second analog filter bandwidth.

In some embodiments, the configuration of the transition between the multiple operational states may comprise a configuration for an operational state transition from one operational state to another operational state, wherein a second analog filter with a wider bandwidth can be used for both of the one operational state and the another operational state, and wherein a number of MIMO rank in the another operational state is capable of being decreased compared to a number of MIMO rank in the one operational state.

In some embodiments, the decreased number of MIMO rank in the another operational state may deactivate at least one RF chain, and wherein the deactivated RF chain is used for at least either adding inter-band combinations or increasing carriers in another fragmented carrier aggregation bands.

In some embodiments, the configuration of the transition between the multiple operational states may comprise a configuration for an operational state transition from the another operational state to the one operational state.

In some embodiments, the one operational state may comprise 4 MIMO layers, 1 RX chain, and the second analog filter bandwidth with wider bandwidth than the first analog filter bandwidth; the another operational stage comprises 2 MIMO layer with diversity, 2RX chains, and the second analog filter bandwidth with wider bandwidth than the first analog filter bandwidth.

In some embodiments, the example method 1200 may comprise: configuring the terminal device to support the multiple operational states of a same activation of hardware to support different levels of carrier aggregation based on at least one of the followings: presence of in-gap interference; inter-band combination demand; number of connectable RX antennas; or actual MIMO rank.

In some embodiments, the configuration of the transition between the multiple operational states may comprise a first configuration for the apparatus to transition to or remain in a first operational state, the first configuration comprises multiple configured component carriers, on at least a first band of the band combinations, and in the first operational state, for a component carrier of the multiple configured component carriers, a first number of RX chains are activated.

In some embodiments, the multiple configured component carriers may comprise three component carriers with each one on three individual bands; on the respective bands, the number of MIMO layers is 4; the first number of the activated RX chains is 2, and the first analog filter bandwidth with narrower bandwidth than the second analog filter bandwidth is used for each of the activated RX chains.

In some embodiments, the configuration of the transition between the multiple operational states may comprise a second configuration for the apparatus to transition to or remain in a second operational state, the second configuration comprises the multiple configured component carriers, and in the second operational state, for a first component carrier of the multiple configured component carriers, a number, reduced from the first number, of RX chains is activated for the first component carrier and a number of RX chains beyond the reduced number are deactivated.

In some embodiments, the first component carrier may be on the first band, the multiple configured component carriers may be on the first band and two additional bands; on the respective two component carriers configured on the two additional band, the number of MIMO layers is 4; the first number of the activated RX chains is 2, and the first analog filter bandwidth with narrower bandwidth than the second analog filter bandwidth is used; on the first component carrier of the first band, the number of MIMO layers is 2; the number of the activated RX chains is 1, and the first analog filter bandwidth with narrower bandwidth than the second analog filter bandwidth is used.

In some embodiments, the configuration of the transition between the multiple operational states may comprise a third configuration for the apparatus to transition to or remain in a third operational state, the third configuration comprises a second component carrier on a band besides the band combinations of the three previously used bands, and in the third operational state, the deactivated RX chains are activated for the second component carrier.

In some embodiments, the second component carrier of the multiple configured component carriers may be on a fourth band besides the band combinations of the three previously used bands; on the second component carrier on the fourth band of, the number of MIMO layers is 2; the number of the activated RX chains is 1, and the first analog filter bandwidth with narrower bandwidth than the second analog filter bandwidth is used; on respective two component carriers of the second and third bands, the number of MIMO layers is 4; the first number of the activated RX chains is 2, and the first analog filter bandwidth with narrower bandwidth than the second analog filter bandwidth is used; on the first component carrier of the first band, the number of MIMO layers is 2; the number of the activated RX chains is 1, and the first analog filter bandwidth with narrower bandwidth than the second analog filter bandwidth is used.

In some embodiments, the configuration of the transition between the multiple operational states may comprise a fourth configuration for the apparatus to transition to or remain in a fourth operational state, the fourth configuration comprises a third component carrier on the first band, and in the fourth operational state, the first band having been configured to receive a fourth component carrier is reconfigured for receiving the third component carrier while also receiving the fourth component carrier, and a second analog filter which has wider bandwidth is used on the first band.

In some embodiments, the third component carrier and the fourth component carrier may be both on the first band; on the fourth band, the number of MIMO layers is 2; the number of the activated RX chains is 1, and the first analog filter bandwidth with narrower bandwidth than the second analog filter bandwidth is used; on respective two component carriers of the second and third bands, the number of MIMO layers is 4; the first number of the activated RX chains is 2, and the first analog filter bandwidth with narrower bandwidth than the second analog filter bandwidth is used; on the respective one of the third and the fourth component carriers on the first band, the number of MIMO layers is 2; the number of the activated RX chains is 1, and the second analog filter bandwidth with wider bandwidth than the first analog filter bandwidth is used.

In some embodiments, the first band may be n66, the second band may be n7, the third band may be n25, and/or the fourth band may be n5.

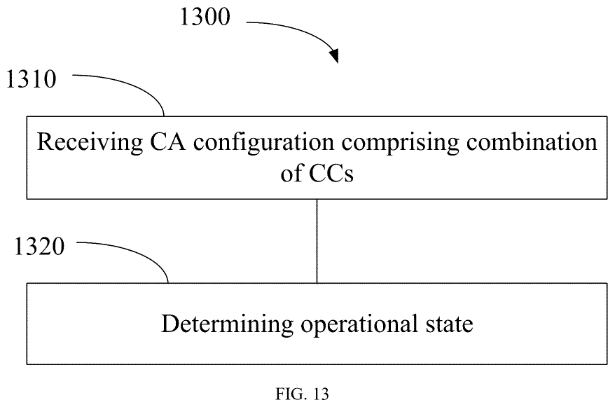

FIG. 13 shows a flow chart illustrating an example method 1300 according to the example embodiments of the present disclosure. The example method 1300 may be performed, for example, by an apparatus for a terminal device, such as the UE 110 above mentioned.

Referring to FIG. 13, the example method 1300 may comprise: an operation 1310 of receiving a carrier aggregation configuration comprising at least one combination of component carriers; and an operation 1320 of in response to receiving the carrier aggregation configuration, determining an operational state for receiving a configured combination of component carriers from the at least one combination of component carriers, wherein the operational state is used to determine at least one of: a number of activated RX antennas or a number of RX chains.

In some embodiments, the operational state may be a combination of at least one of: a number of multi-input multi-output, MIMO, layers, a number of RX chains, and analog filter bandwidth.

In some embodiments, the number of MIMO layers may be more than one; the number of RX chains may comprise at least one of: 1 RX chain, 2 RX chains per MIMO layer; and the analog filter bandwidth may comprise: either a first analog filter bandwidth, or a second analog filter bandwidth, and the first analog bandwidth is narrower than the second analog bandwidth.

In some embodiments, the number of the RX chains for a same carrier may be determined based on a receive condition at the apparatus, wherein poorer receive condition demands larger number of RX chains, and better receive condition relaxes the number of RX chains.

In some embodiments, the example method 1300 may comprise: deactivating at least one RX chain of the same carrier when the receive condition is above a threshold, and the deactivated at least one RX chain is used as spare RX chain.

In some embodiments, the at least one spare RX chain may be used for at least one of: increasing inter-band combinations or increasing fragments in fragmented carrier aggregation band of the band combinations.

In some embodiments, the example method 1300 may comprise: determining to use the combination of component carriers configured from a network.

In some embodiments, the example method 1300 may comprise: supporting multiple operational states of a same activation of hardware to support different levels of carrier aggregation based on at least one of the following conditions: presence of in-gap interference, inter-band combination demand, a number of connectable receive antennas, or an actual MIMO rank.

In some embodiments, the example method 1300 may comprise: determining the operational state by selecting antennas based on receiving quality of the antennas with respect to the configured combination of component carriers.

In some embodiments, the example method 1300 may comprise: using a second number, reduced from a first number, of active antennas for respective non-contiguous intra-band component carriers, where an active antenna of the second number of active antennas is used for one component carrier; and deactivating a third number of antennas, within the first number of antennas, beyond the second number of antennas.

In some embodiments, the example method 1300 may comprise: using a second number, reduced from a first number, of active receive chains at respective antennas for non-contiguous intra-band component carriers, where one active receive chain at the respective antennas is used for the component carriers utilizing a wider analogue filter on the band; and deactivating a third number of receive chains at the respective antennas, within the first number of receive chains at the respective antennas, beyond the second number.

In some embodiments, the example method 1300 may comprise: using a first number of active antennas for component carriers on bands comprising at least a first band and a second band, where an active antenna of the first number of active antennas is used for the component carriers on the first band and the second band utilizing wider analogue filters on the first band and the second band.

In some embodiments, the example method 1300 may comprise: using a first number of active antennas for component carriers on bands comprising at least a first band and a second band, where an active antenna of a second number, reduced from the first number, of active antennas is used for the component carriers on the first band utilizing a wider analogue filter on the first band, and an active antenna of a third number, reduced from the first number, of active antennas is used for the component carriers on the second band utilizing a wider analogue filter on the second band.

In some embodiments, the example method 1300 may comprise: using a fourth number of antennas, within the first number of antennas for the component carriers on the third band where an active antenna of the fourth number of active antennas is used for the component carriers on the third band utilizing a wider analogue filter on the third band.

In some embodiments, the example method 1300 may comprise: mapping the antennas to the component carriers based on receiving performance.

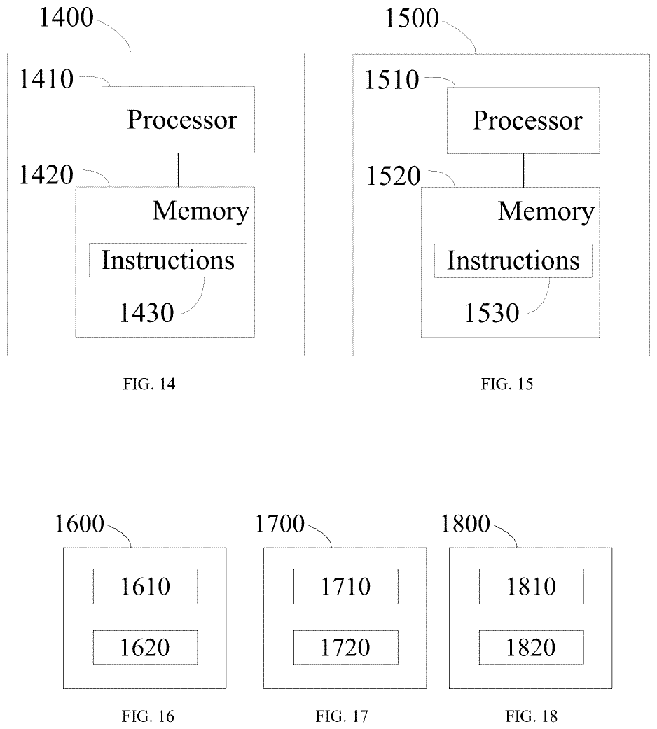

FIG. 14 shows a block diagram illustrating an example device 1400 according to the example embodiments of the present disclosure. The device, for example, may be at least part of an apparatus for a terminal device, such as the UE 110 in the above examples.

As shown in FIG. 14, the example device 1400 may comprise at least one processor 1410 and at least one memory 1420 that may store instructions 1430. The instructions 1430, when executed by the at least one processor 1410, may cause the device 1400 at least to perform the example method 1100 or the example method 1300 described above.

In various example embodiments, the at least one processor 1410 in the example device 1400 may comprise, but is not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 1410 may also include at least one other circuitry or element not shown in FIG. 14.

In various example embodiments, the at least one memory 1420 in the example device 1400 may comprise at least one storage medium in various forms, such as a transitory memory and/or a non-transitory memory. The transitory memory may include, but is not limited to, for example, a random-access memory (RAM), a cache, and so on. The non-transitory memory may include, but is not limited to, for example, a read-only memory (ROM), a hard disk, a flash memory, and so on. The term “non-transitory,” as used herein, is a limitation of the medium itself (i.e., tangible, not a signal) as opposed to a limitation on data storage persistency (e.g., RAM vs. ROM). Further, the at least memory 1420 may include, but is not limited to, an electric, a magnetic, an optical, an electromagnetic, an infrared, or a semiconductor system, apparatus, or device or any combination of the above.

Further, in various example embodiments, the example device 1400 may also include at least one other circuitry, element, and interface, for example at least one I/O interface, at least one antenna element, and the like.

In various example embodiments, the circuitries, parts, elements, and interfaces in the example device 1400, comprising the at least one processor 810 and the at least one memory 1420, may be coupled together via any suitable connections including, but is not limited to, buses, crossbars, wiring and/or wireless lines, in any suitable ways, for example electrically, magnetically, optically, electromagnetically, and the like.

It is understood that the structure of the device on the side of the UE 110 is not limited to the above example device 1400.

FIG. 15 shows a block diagram illustrating an example device 1500 for authentication according to the example embodiments of the present disclosure. The device, for example, may be at least part of an apparatus for a network device, such as the network device 150 in the above examples.

As shown in FIG. 15, the example device 1500 may comprise at least one processor 1510 and at least one memory 1520 that may store instructions 1530. The instructions 1530, when executed by the at least one processor 1510, may cause the device 1500 at least to perform the example method 1200 described above.

In various example embodiments, the at least one processor 1510 in the example device 1500 may comprise, but is not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 1510 may also include at least one other circuitry or element not shown in FIG. 15.

In various example embodiments, the at least one memory 1520 in the example device 1500 may comprise at least one storage medium in various forms, such as a transitory memory and/or a non-transitory memory. The transitory memory may include, but is not limited to, for example, a random-access memory (RAM), a cache, and so on. The non-transitory memory may include, but is not limited to, for example, a read-only memory (ROM), a hard disk, a flash memory, and so on. The term “non-transitory,” as used herein, is a limitation of the medium itself (i.e., tangible, not a signal) as opposed to a limitation on data storage persistency (e.g., RAM vs. ROM). Further, the at least memory 1520 may include, but is not limited to, an electric, a magnetic, an optical, an electromagnetic, an infrared, or a semiconductor system, apparatus, or device or any combination of the above.

Further, in various example embodiments, the example device 1500 may also include at least one other circuitry, element, and interface, for example at least one I/O interface, at least one antenna element, and the like.

In various example embodiments, the circuitries, parts, elements, and interfaces in the example device 1500, including the at least one processor 1510 and the at least one memory 1520, may be coupled together via any suitable connections including, but is not limited to, buses, crossbars, wiring and/or wireless lines, in any suitable ways, for example electrically, magnetically, optically, electromagnetically, and the like.

It is understood that the structure of the device on the side of the network device 150 is not limited to the above example device 1500.

FIG. 16 shows a block diagram illustrating an example apparatus 1600 according to the example embodiments of the present disclosure. The apparatus, for example, may be at least part of a terminal device, such as the UE 110 in the above examples.

As shown in FIG. 16, the example apparatus 1600 may comprise: means 1610 for transmitting, to a network node, capabilities of the apparatus comprising at least one of band combinations supported by the apparatus, fragmented carriers supported by the apparatus, and multiple operational states supported by the apparatus associated with MIMO reception across multiple antennas that enable multiple MIMO layers; and means 1620 for receiving, from the network node, a configuration of a transition between the multiple operational states; wherein one operational state of the multiple operational states is used to determine at least one of: a number of activated RX antennas or a number of RX chains.

In some embodiments, the one operational state of the multiple operational states may be a combination of at least one of: a number of MIMO layers, a number of RX chains, and analog filter bandwidth.

In some embodiments, the number of MIMO layers may be more than one; the number of RX chains may comprise at least one of: 1 RX chain, 2 RX chains per MIMO layer; and the analog filter bandwidth may comprise: either a first analog filter bandwidth, or a second analog filter bandwidth, and the first analog bandwidth is narrower than the second analog bandwidth.

In some embodiments, the number of the RX chains for a same carrier may be determined based on a receive condition at the apparatus, wherein poorer receive condition may demand larger number of RX chains, and better receive condition may relaxe number of RX chains.

In some embodiments, the apparatus 1600 may comprise: means for relaxing at least one RX chain of the same carrier when the receive condition is above a threshold, and the relaxed at least one RX chain may be used as spare RX chain.

In some embodiments, the at least one spare RX chain may be used for at least one of: increasing inter-band combinations or increasing fragments in fragmented carrier aggregation band of the band combinations.

In some embodiments, the configuration of the transition between the multiple operational states may comprise a configuration for an operational state transition from one operational state to another operational state, and wherein in response to in-gap interference being lower than a threshold, the another operational state has reduced number of RF chains in a same carrier than the one operational state; the another operational state utilizes the second analog filter which has wider bandwidth than the one operational state.

In some embodiments, the second analog filter which has the wider bandwidth filter may be used to receive both intra-band, non-contiguous component carriers for at least one MIMO layer.

In some embodiments, the configuration of the transition between the multiple operational states may comprise a configuration for an operational state transition from the another operational state to the one operational state, in response to in-gap interferer being above a threshold.

In some embodiments, the one operational state may comprise 4 MIMO layers, 1 RX chain, and the second analog filter bandwidth with wider bandwidth than the first analog filter bandwidth; the another operational state may comprise 4 MIMO layer, 2RX chains, and the first analog filter bandwidth with narrower bandwidth than the second analog filter bandwidth.

In some embodiments, the configuration of the transition between the multiple operational states may comprises a configuration for an operational state transition from one operational state to another operational state, wherein a second analog filter with a wider bandwidth can be used for both of the one operational state and the another operational state, and wherein a number of MIMO rank in the another operational state is capable of being decreased compared to a number of MIMO rank in the one operational state.

In some embodiments, the decreased number of MIMO rank in the another operational state may deactivate at least one RF chain, and wherein the deactivated RF chain is used for at least either adding inter-band combinations or increasing carriers in another fragmented carrier aggregation bands.

In some embodiments, the configuration of the transition between the multiple operational states may comprises a configuration for an operational state transition from the another operational state to the one operational state.

In some embodiments, the one operational state may comprise 4 MIMO layers, 1 RX chain, and the second analog filter bandwidth with wider bandwidth than the first analog filter bandwidth; the another operational state may comprise 2 MIMO layer with diversity, 2RX chains, and the second analog filter bandwidth with wider bandwidth than the first analog filter bandwidth.

In some embodiments, the apparatus 1600 may comprise: means for supporting the multiple operational states of a same activation of hardware to support different levels of carrier aggregation based on at least one of the followings: presence of in-gap interference; inter-band combination demand; number of connectable RX antennas; or actual MIMO rank.

In some embodiments, the configuration of the transition between the multiple operational states may comprise a first configuration for the apparatus to transition to or remain in a first operational state, the first configuration comprises multiple configured component carriers, on at least a first band of the band combinations, and in the first operational state, for a component carrier of the multiple configured component carriers, a first number of RX chains are activated.

In some embodiments, the multiple configured component carriers may comprise three component carriers with each one on three individual bands; on the respective bands, the number of MIMO layers is 4; the first number of the activated RX chains is 2, and the first analog filter bandwidth with narrower bandwidth than the second analog filter bandwidth is used for each of the activated RX chains.

In some embodiments, the configuration of the transition between the multiple operational states may comprise a second configuration for the apparatus to transition to or remain in a second operational state, the second configuration comprises the multiple configured component carriers, and in the second operational state, for a first component carrier of the multiple configured component carriers, a number, reduced from the first number, of RX chains is activated for the first component carrier and a number of RX chains beyond the reduced number are deactivated.

In some embodiments, the first component carrier may be on the first band, the multiple configured component carriers may be on the first band and two additional bands; on the respective two component carriers configured on the two additional band, the number of MIMO layers is 4; the first number of the activated RX chains is 2, and the first analog filter bandwidth with narrower bandwidth than the second analog filter bandwidth is used; on the first component carrier of the first band, the number of MIMO layers is 2; the number of the activated RX chains is 1, and the first analog filter bandwidth with narrower bandwidth than the second analog filter bandwidth is used.

In some embodiments, the configuration of the transition between the multiple operational states may comprise a third configuration for the apparatus to transition to or remain in a third operational state, the third configuration comprises a second component carrier on a band besides the band combinations of the three previously used bands, and in the third operational state, the deactivated RX chains are activated for the second component carrier.

In some embodiments, the second component carrier of the multiple configured component carriers is on a fourth band besides the band combinations of the three previously used bands; on the second component carrier on the fourth band of, the number of MIMO layers is 2; the number of the activated RX chains is 1, and the first analog filter bandwidth with narrower bandwidth than the second analog filter bandwidth is used; on respective two component carriers of the second and third bands, the number of MIMO layers is 4; the first number of the activated RX chains is 2, and the first analog filter bandwidth with narrower bandwidth than the second analog filter bandwidth is used; on the first component carrier of the first band, the number of MIMO layers is 2; the number of the activated RX chains is 1, and the first analog filter bandwidth with narrower bandwidth than the second analog filter bandwidth is used.

In some embodiments, the configuration of the transition between the multiple operational states comprises a fourth configuration for the apparatus to transition to or remain in a fourth operational state, the fourth configuration comprises a third component carrier on the first band, and in the fourth operational state, the first band having been configured to receive a fourth component carrier is reconfigured for receiving the third component carrier while also receiving the fourth component carrier, and a second analog filter which has wider bandwidth is used on the first band.

In some embodiments, the third component carrier and the fourth component carrier are both on the first band; on the fourth band, the number of MIMO layers is 2; the number of the activated RX chains is 1, and the first analog filter bandwidth with narrower bandwidth than the second analog filter bandwidth is used; on respective two component carriers of the second and third bands, the number of MIMO layers is 4; the first number of the activated RX chains is 2, and the first analog filter bandwidth with narrower bandwidth than the second analog filter bandwidth is used; on the respective one of the third and the fourth component carriers on the first band, the number of MIMO layers is 2; the number of the activated RX chains is 1, and the second analog filter bandwidth with wider bandwidth than the first analog filter bandwidth is used.

In some embodiments, the first band may be n66, the second band may be n7, the third band may be n25, and/or the fourth band may be n5.

In some example embodiments, examples of means in the example apparatus 1600 may include circuitries. For example, an example of means 1610 may include a circuitry configured to perform the operation 1110 of the example method 1100, and an example of means 1620 may include a circuitry configured to perform the operation 1120 of the example method 1100.

The example apparatus 1600 may further include means comprising circuitry configured to perform the example method 1100. In some example embodiments, examples of means may also include software modules and any other suitable function entities.

FIG. 17 shows a block diagram illustrating an example apparatus 1700 according to the example embodiments of the present disclosure. The apparatus, for example, may be at least part of a network device, such as the network device 150 in the above examples.

As shown in FIG. 17, the example apparatus 1700 may comprise: means 1710 for receiving, from a terminal device, capabilities of the apparatus comprising at least one of band combinations supported by the terminal device, fragmented carriers supported by the terminal device, and multiple operational states supported by the terminal device associated with MIMO reception across multiple antennas that enable multiple MIMO layers; and means 1720 for transmitting, to the terminal device, a configuration comprising a transition between the multiple operational states, wherein one operational state of the multiple operational states is used to determine at least one of: a number of activated RX antennas or a number of RX chains.

In some embodiments, the one operational state of the multiple operational states may be a combination of at least one of: a number of MIMO layers, a number of RX chains, and analog filter bandwidth.

In some embodiments, the number of MIMO layers may be more than one; the number of RX chains may comprise at least one of: 1 RX chain, 2 RX chains per MIMO layer; and the analog filter bandwidth may comprise: either a first analog filter bandwidth, or a second analog filter bandwidth, and the first analog bandwidth is narrower than the second analog bandwidth.

In some embodiments, the number of the RX chains for a same carrier may be determined based on a receive condition at the terminal device, wherein poorer receive condition demands larger number of RX chains, and better receive condition relaxes the number of RX chains.

In some embodiments, the apparatus 1700 may comprise: means for determining to deactivate at least one RX chain of the same carrier when the receive condition is above a threshold, and the deactivated at least one RX chain is used as spare RX chain.

In some embodiments, the at least one spare RX chain may be used for at least one of: increasing inter-band combinations or increasing fragments in fragmented carrier aggregation bands of the band combinations.

In some embodiments, the configuration of the transition between the multiple operational states may comprise a configuration for an operational state transition from one operational state to another operational state, and wherein in response to in-gap interference being lower than a threshold, the another operational state has reduced number of RF chains in a same carrier than the one operational state; the another operational state utilizes the second analog filter which has wider bandwidth than the one operational state.

In some embodiments, the second analog filter which has the wider bandwidth filter may be used to receive both intra-band, non-contiguous component carriers for at least one MIMO layer.

In some embodiments, the configuration of the transition between the multiple operational states may comprise a configuration for an operational state transition from the another operational state to the one operational state, in response to in-gap interferer is being above than a threshold.

In some embodiments, the one operational state may comprise 4 MIMO layers, 1 RX chain, and the second analog filter bandwidth with wider bandwidth than the first analog filter bandwidth; the another operational state comprises 4 MIMO layer, 2RX chains, and the first analog filter bandwidth with narrower bandwidth than the second analog filter bandwidth.

In some embodiments, the configuration of the transition between the multiple operational states may comprise a configuration for an operational state transition from one operational state to another operational state, wherein a second analog filter with a wider bandwidth can be used for both of the one operational state and the another operational state, and wherein a number of MIMO rank in the another operational state is capable of being decreased compared to a number of MIMO rank in the one operational state.

In some embodiments, the decreased number of MIMO rank in the another operational state may deactivate at least one RF chain, and wherein the deactivated RF chain is used for at least either adding inter-band combinations or increasing carriers in another fragmented carrier aggregation bands.

In some embodiments, the configuration of the transition between the multiple operational states may comprise a configuration for an operational state transition from the another operational state to the one operational state.

In some embodiments, the one operational state may comprise 4 MIMO layers, 1 RX chain, and the second analog filter bandwidth with wider bandwidth than the first analog filter bandwidth; the another operational stage comprises 2 MIMO layer with diversity, 2RX chains, and the second analog filter bandwidth with wider bandwidth than the first analog filter bandwidth.

In some embodiments, the apparatus 1700 may comprise: means for configuring the terminal device to support the multiple operational states of a same activation of hardware to support different levels of carrier aggregation based on at least one of the followings: presence of in-gap interference; inter-band combination demand; number of connectable RX antennas; or actual MIMO rank.

In some embodiments, the configuration of the transition between the multiple operational states may comprise a first configuration for the apparatus to transition to or remain in a first operational state, the first configuration comprises multiple configured component carriers, on at least a first band of the band combinations, and in the first operational state, for a component carrier of the multiple configured component carriers, a first number of RX chains are activated.

In some embodiments, the multiple configured component carriers may comprise three component carriers with each one on three individual bands; on the respective bands, the number of MIMO layers is 4; the first number of the activated RX chains is 2, and the first analog filter bandwidth with narrower bandwidth than the second analog filter bandwidth is used for each of the activated RX chains.

In some embodiments, the configuration of the transition between the multiple operational states may comprise a second configuration for the apparatus to transition to or remain in a second operational state, the second configuration comprises the multiple configured component carriers, and in the second operational state, for a first component carrier of the multiple configured component carriers, a number, reduced from the first number, of RX chains is activated for the first component carrier and a number of RX chains beyond the reduced number are deactivated.

In some embodiments, the first component carrier may be on the first band, the multiple configured component carriers may be on the first band and two additional bands; on the respective two component carriers configured on the two additional band, the number of MIMO layers is 4; the first number of the activated RX chains is 2, and the first analog filter bandwidth with narrower bandwidth than the second analog filter bandwidth is used; on the first component carrier of the first band, the number of MIMO layers is 2; the number of the activated RX chains is 1, and the first analog filter bandwidth with narrower bandwidth than the second analog filter bandwidth is used.

In some embodiments, the configuration of the transition between the multiple operational states may comprise a third configuration for the apparatus to transition to or remain in a third operational state, the third configuration comprises a second component carrier on a band besides the band combinations of the three previously used bands, and in the third operational state, the deactivated RX chains are activated for the second component carrier.

In some embodiments, the second component carrier of the multiple configured component carriers may be on a fourth band besides the band combinations of the three previously used bands; on the second component carrier on the fourth band of, the number of MIMO layers is 2; the number of the activated RX chains is 1, and the first analog filter bandwidth with narrower bandwidth than the second analog filter bandwidth is used; on respective two component carriers of the second and third bands, the number of MIMO layers is 4; the first number of the activated RX chains is 2, and the first analog filter bandwidth with narrower bandwidth than the second analog filter bandwidth is used; on the first component carrier of the first band, the number of MIMO layers is 2; the number of the activated RX chains is 1, and the first analog filter bandwidth with narrower bandwidth than the second analog filter bandwidth is used.

In some embodiments, the configuration of the transition between the multiple operational states may comprise a fourth configuration for the apparatus to transition to or remain in a fourth operational state, the fourth configuration comprises a third component carrier on the first band, and in the fourth operational state, the first band having been configured to receive a fourth component carrier is reconfigured for receiving the third component carrier while also receiving the fourth component carrier, and a second analog filter which has wider bandwidth is used on the first band.

In some embodiments, the third component carrier and the fourth component carrier may be both on the first band; on the fourth band, the number of MIMO layers is 2; the number of the activated RX chains is 1, and the first analog filter bandwidth with narrower bandwidth than the second analog filter bandwidth is used; on respective two component carriers of the second and third bands, the number of MIMO layers is 4; the first number of the activated RX chains is 2, and the first analog filter bandwidth with narrower bandwidth than the second analog filter bandwidth is used; on the respective one of the third and the fourth component carriers on the first band, the number of MIMO layers is 2; the number of the activated RX chains is 1, and the second analog filter bandwidth with wider bandwidth than the first analog filter bandwidth is used.

In some embodiments, the first band may be n66, the second band may be n7, the third band may be n25, and/or the fourth band may be n5.

In some example embodiments, examples of means in the example apparatus 1700 may include circuitries. For example, an example of means 1710 may include a circuitry configured to perform the operation 1210 of the example method 1200, and an example of means 1720 may include a circuitry configured to perform the operation 1220 of the example method 1200.

The example apparatus 1700 may further include means comprising circuitry configured to perform the example method 1200. In some example embodiments, examples of means may also include software modules and any other suitable function entities.

FIG. 18 shows a block diagram illustrating an example apparatus 1800 according to the example embodiments of the present disclosure. The apparatus, for example, may be at least part of a terminal device, such as the UE 110 in the above examples.

As shown in FIG. 18, the example apparatus 1800 may comprise: means 1810 for receiving a carrier aggregation configuration comprising at least one combination of component carriers; and means 1820 for in response to receiving the carrier aggregation configuration, determining an operational state for receiving a configured combination of component carriers from the at least one combination of component carriers, wherein the operational state is used to determine at least one of: a number of activated RX antennas or a number of RX chains.

In some embodiments, the operational state may be a combination of at least one of: a number of multi-input multi-output, MIMO, layers, a number of RX chains, and analog filter bandwidth.

In some embodiments, the number of MIMO layers may be more than one; the number of RX chains may comprise at least one of: 1 RX chain, 2 RX chains per MIMO layer; and the analog filter bandwidth may comprise: either a first analog filter bandwidth, or a second analog filter bandwidth, and the first analog bandwidth is narrower than the second analog bandwidth.

In some embodiments, the number of the RX chains for a same carrier may be determined based on a receive condition at the apparatus, wherein poorer receive condition demands larger number of RX chains, and better receive condition relaxes the number of RX chains.

In some embodiments, the apparatus 1800 may comprise: means for deactivating at least one RX chain of the same carrier when the receive condition is above a threshold, and the deactivated at least one RX chain is used as spare RX chain.

In some embodiments, the at least one spare RX chain may be used for at least one of: increasing inter-band combinations or increasing fragments in fragmented carrier aggregation band of the band combinations.

In some embodiments, the apparatus 1800 may comprise: means for determining to use the combination of component carriers configured from a network.

In some embodiments, the apparatus 1800 may comprise: means for supporting multiple operational states of a same activation of hardware to support different levels of carrier aggregation based on at least one of the following conditions: presence of in-gap interference, inter-band combination demand, a number of connectable receive antennas, or an actual MIMO rank.

In some embodiments, the apparatus 1800 may comprise: means for determining the operational state by selecting antennas based on receiving quality of the antennas with respect to the configured combination of component carriers.

In some embodiments, the apparatus 1800 may comprise: means for using a second number, reduced from a first number, of active antennas for respective non-contiguous intra-band component carriers, where an active antenna of the second number of active antennas is used for one component carrier; and means for deactivating a third number of antennas, within the first number of antennas, beyond the second number of antennas.

In some embodiments, the apparatus 1800 may comprise: means for using a second number, reduced from a first number, of active receive chains at respective antennas for non-contiguous intra-band component carriers, where one active receive chain at the respective antennas is used for the component carriers utilizing a wider analogue filter on the band; and deactivating a third number of receive chains at the respective antennas, within the first number of receive chains at the respective antennas, beyond the second number.

In some embodiments, the apparatus 1800 may comprise: means for using a first number of active antennas for component carriers on bands comprising at least a first band and a second band, where an active antenna of the first number of active antennas is used for the component carriers on the first band and the second band utilizing wider analogue filters on the first band and the second band.

In some embodiments, the apparatus 1800 may comprise: means for using a first number of active antennas for component carriers on bands comprising at least a first band and a second band, where an active antenna of a second number, reduced from the first number, of active antennas is used for the component carriers on the first band utilizing a wider analogue filter on the first band, and an active antenna of a third number, reduced from the first number, of active antennas is used for the component carriers on the second band utilizing a wider analogue filter on the second band.

In some embodiments, the apparatus 1800 may comprise: means for using a fourth number of antennas, within the first number of antennas for the component carriers on the third band where an active antenna of the fourth number of active antennas is used for the component carriers on the third band utilizing a wider analogue filter on the third band.

In some embodiments, the apparatus 1800 may comprise: means for mapping the antennas to the component carriers based on receiving performance.

In some example embodiments, examples of means in the example apparatus 1800 may include circuitries. For example, an example of means 1810 may include a circuitry configured to perform the operation 1310 of the example method 1300, and an example of means 1820 may include a circuitry configured to perform the operation 1320 of the example method 1300.

The example apparatus 1800 may further include means comprising circuitry configured to perform the example method 1300. In some example embodiments, examples of means may also include software modules and any other suitable function entities.

The example embodiments of the present disclosure also provide a computer-readable medium comprising program instructions that, when executed by an apparatus for a terminal device, such as the UE 110 in the above examples, may cause the apparatus at least to: transmit, to a network node, capabilities of the apparatus comprising at least one of band combinations supported by the apparatus, fragmented carriers supported by the apparatus, and multiple operational states supported by the apparatus associated with MIMO reception across multiple antennas that enable multiple MIMO layers; and receive, from the network node, a configuration of a transition between the multiple operational states; wherein one operational state of the multiple operational states is used to determine at least one of: a number of activated RX antennas or a number of RX chains.

In some embodiments, the one operational state of the multiple operational states may be a combination of at least one of: a number of MIMO layers, a number of RX chains, and analog filter bandwidth.

In some embodiments, the number of MIMO layers may be more than one; the number of RX chains may comprise at least one of: 1 RX chain, 2 RX chains per MIMO layer; and the analog filter bandwidth may comprise: either a first analog filter bandwidth, or a second analog filter bandwidth, and the first analog bandwidth is narrower than the second analog bandwidth.

In some embodiments, the number of the RX chains for a same carrier may be determined based on a receive condition at the apparatus, wherein poorer receive condition may demand larger number of RX chains, and better receive condition may relaxe number of RX chains.

In some embodiments, the computer-readable medium may include instructions that, when executed by the apparatus, may cause the apparatus to: relax at least one RX chain of the same carrier when the receive condition is above a threshold, and the relaxed at least one RX chain is used as spare RX chain.

In some embodiments, the at least one spare RX chain may be used for at least one of: increasing inter-band combinations or increasing fragments in fragmented carrier aggregation band of the band combinations.

In some embodiments, the configuration of the transition between the multiple operational states may comprise a configuration for an operational state transition from one operational state to another operational state, and wherein in response to in-gap interference being lower than a threshold, the another operational state has reduced number of RF chains in a same carrier than the one operational state; the another operational state utilizes the second analog filter which has wider bandwidth than the one operational state.

In some embodiments, the second analog filter which has the wider bandwidth filter may be used to receive both intra-band, non-contiguous component carriers for at least one MIMO layer.

In some embodiments, the configuration of the transition between the multiple operational states may comprise a configuration for an operational state transition from the another operational state to the one operational state, in response to in-gap interferer being above a threshold.

In some embodiments, the one operational state may comprise 4 MIMO layers, 1 RX chain, and the second analog filter bandwidth with wider bandwidth than the first analog filter bandwidth; the another operational state may comprise 4 MIMO layer, 2RX chains, and the first analog filter bandwidth with narrower bandwidth than the second analog filter bandwidth.

In some embodiments, the configuration of the transition between the multiple operational states may comprises a configuration for an operational state transition from one operational state to another operational state, wherein a second analog filter with a wider bandwidth can be used for both of the one operational state and the another operational state, and wherein a number of MIMO rank in the another operational state is capable of being decreased compared to a number of MIMO rank in the one operational state.

In some embodiments, the decreased number of MIMO rank in the another operational state may deactivate at least one RF chain, and wherein the deactivated RF chain is used for at least either adding inter-band combinations or increasing carriers in another fragmented carrier aggregation bands.

In some embodiments, the configuration of the transition between the multiple operational states may comprises a configuration for an operational state transition from the another operational state to the one operational state.

In some embodiments, the one operational state may comprise 4 MIMO layers, 1 RX chain, and the second analog filter bandwidth with wider bandwidth than the first analog filter bandwidth; the another operational state may comprise 2 MIMO layer with diversity, 2RX chains, and the second analog filter bandwidth with wider bandwidth than the first analog filter bandwidth.

In some embodiments, the computer-readable medium may include instructions that, when executed by the apparatus, may cause the apparatus to: support the multiple operational states of a same activation of hardware to support different levels of carrier aggregation based on at least one of the followings: presence of in-gap interference; inter-band combination demand; number of connectable RX antennas; or actual MIMO rank.

In some embodiments, the configuration of the transition between the multiple operational states may comprise a first configuration for the apparatus to transition to or remain in a first operational state, the first configuration comprises multiple configured component carriers, on at least a first band of the band combinations, and in the first operational state, for a component carrier of the multiple configured component carriers, a first number of RX chains are activated.

In some embodiments, the multiple configured component carriers may comprise three component carriers with each one on three individual bands; on the respective bands, the number of MIMO layers is 4; the first number of the activated RX chains is 2, and the first analog filter bandwidth with narrower bandwidth than the second analog filter bandwidth is used for each of the activated RX chains.

In some embodiments, the configuration of the transition between the multiple operational states may comprise a second configuration for the apparatus to transition to or remain in a second operational state, the second configuration comprises the multiple configured component carriers, and in the second operational state, for a first component carrier of the multiple configured component carriers, a number, reduced from the first number, of RX chains is activated for the first component carrier and a number of RX chains beyond the reduced number are deactivated.

In some embodiments, the first component carrier may be on the first band, the multiple configured component carriers may be on the first band and two additional bands; on the respective two component carriers configured on the two additional band, the number of MIMO layers is 4; the first number of the activated RX chains is 2, and the first analog filter bandwidth with narrower bandwidth than the second analog filter bandwidth is used; on the first component carrier of the first band, the number of MIMO layers is 2; the number of the activated RX chains is 1, and the first analog filter bandwidth with narrower bandwidth than the second analog filter bandwidth is used.

In some embodiments, the configuration of the transition between the multiple operational states may comprise a third configuration for the apparatus to transition to or remain in a third operational state, the third configuration comprises a second component carrier on a band besides the band combinations of the three previously used bands, and in the third operational state, the deactivated RX chains are activated for the second component carrier.

In some embodiments, the second component carrier of the multiple configured component carriers is on a fourth band besides the band combinations of the three previously used bands; on the second component carrier on the fourth band of, the number of MIMO layers is 2; the number of the activated RX chains is 1, and the first analog filter bandwidth with narrower bandwidth than the second analog filter bandwidth is used; on respective two component carriers of the second and third bands, the number of MIMO layers is 4; the first number of the activated RX chains is 2, and the first analog filter bandwidth with narrower bandwidth than the second analog filter bandwidth is used; on the first component carrier of the first band, the number of MIMO layers is 2; the number of the activated RX chains is 1, and the first analog filter bandwidth with narrower bandwidth than the second analog filter bandwidth is used.

In some embodiments, the configuration of the transition between the multiple operational states comprises a fourth configuration for the apparatus to transition to or remain in a fourth operational state, the fourth configuration comprises a third component carrier on the first band, and in the fourth operational state, the first band having been configured to receive a fourth component carrier is reconfigured for receiving the third component carrier while also receiving the fourth component carrier, and a second analog filter which has wider bandwidth is used on the first band.

In some embodiments, the third component carrier and the fourth component carrier are both on the first band; on the fourth band, the number of MIMO layers is 2; the number of the activated RX chains is 1, and the first analog filter bandwidth with narrower bandwidth than the second analog filter bandwidth is used; on respective two component carriers of the second and third bands, the number of MIMO layers is 4; the first number of the activated RX chains is 2, and the first analog filter bandwidth with narrower bandwidth than the second analog filter bandwidth is used; on the respective one of the third and the fourth component carriers on the first band, the number of MIMO layers is 2; the number of the activated RX chains is 1, and the second analog filter bandwidth with wider bandwidth than the first analog filter bandwidth is used.

In some embodiments, the first band may be n66, the second band may be n7, the third band may be n25, and/or the fourth band may be n5.

The example embodiments of the present disclosure also provide a computer-readable medium comprising program instructions that, when executed by an apparatus for a network device, such as the network device 150 in the above examples, may cause the apparatus at least to: receive, from a terminal device, capabilities of the apparatus comprising at least one of band combinations supported by the terminal device, fragmented carriers supported by the terminal device, and multiple operational states supported by the terminal device associated with MIMO reception across multiple antennas that enable multiple MIMO layers; and transmit, to the terminal device, a configuration comprising a transition between the multiple operational states, wherein one operational state of the multiple operational states is used to determine at least one of: a number of activated RX antennas or a number of RX chains.

In some embodiments, the one operational state of the multiple operational states may be a combination of at least one of: a number of MIMO layers, a number of RX chains, and analog filter bandwidth.

In some embodiments, the number of MIMO layers may be more than one; the number of RX chains may comprise at least one of: 1 RX chain, 2 RX chains per MIMO layer; and the analog filter bandwidth may comprise: either a first analog filter bandwidth, or a second analog filter bandwidth, and the first analog bandwidth is narrower than the second analog bandwidth.

In some embodiments, the number of the RX chains for a same carrier may be determined based on a receive condition at the terminal device, wherein poorer receive condition demands larger number of RX chains, and better receive condition relaxes the number of RX chains.

In some embodiments, the computer-readable medium may include instructions that, when executed by the apparatus, may cause the apparatus to: determine to deactivate at least one RX chain of the same carrier when the receive condition is above a threshold, and the deactivated at least one RX chain is used as spare RX chain.

In some embodiments, the at least one spare RX chain may be used for at least one of: increasing inter-band combinations or increasing fragments in fragmented carrier aggregation bands of the band combinations.

In some embodiments, the configuration of the transition between the multiple operational states may comprise a configuration for an operational state transition from one operational state to another operational state, and wherein in response to in-gap interference being lower than a threshold, the another operational state has reduced number of RF chains in a same carrier than the one operational state; the another operational state utilizes the second analog filter which has wider bandwidth than the one operational state.

In some embodiments, the second analog filter which has the wider bandwidth filter may be used to receive both intra-band, non-contiguous component carriers for at least one MIMO layer.

In some embodiments, the configuration of the transition between the multiple operational states may comprise a configuration for an operational state transition from the another operational state to the one operational state, in response to in-gap interferer is being above than a threshold.

In some embodiments, the one operational state may comprise 4 MIMO layers, 1 RX chain, and the second analog filter bandwidth with wider bandwidth than the first analog filter bandwidth; the another operational state comprises 4 MIMO layer, 2RX chains, and the first analog filter bandwidth with narrower bandwidth than the second analog filter bandwidth.

In some embodiments, the configuration of the transition between the multiple operational states may comprise a configuration for an operational state transition from one operational state to another operational state, wherein a second analog filter with a wider bandwidth can be used for both of the one operational state and the another operational state, and wherein a number of MIMO rank in the another operational state is capable of being decreased compared to a number of MIMO rank in the one operational state.

In some embodiments, the decreased number of MIMO rank in the another operational state may deactivate at least one RF chain, and wherein the deactivated RF chain is used for at least either adding inter-band combinations or increasing carriers in another fragmented carrier aggregation bands.

In some embodiments, the configuration of the transition between the multiple operational states may comprise a configuration for an operational state transition from the another operational state to the one operational state.

In some embodiments, the one operational state may comprise 4 MIMO layers, 1 RX chain, and the second analog filter bandwidth with wider bandwidth than the first analog filter bandwidth; the another operational stage comprises 2 MIMO layer with diversity, 2RX chains, and the second analog filter bandwidth with wider bandwidth than the first analog filter bandwidth.

In some embodiments, the computer-readable medium may include instructions that, when executed by the apparatus, may cause the apparatus to: configure the terminal device to support the multiple operational states of a same activation of hardware to support different levels of carrier aggregation based on at least one of the followings: presence of in-gap interference; inter-band combination demand; number of connectable RX antennas; or actual MIMO rank.

In some embodiments, the configuration of the transition between the multiple operational states may comprise a first configuration for the apparatus to transition to or remain in a first operational state, the first configuration comprises multiple configured component carriers, on at least a first band of the band combinations, and in the first operational state, for a component carrier of the multiple configured component carriers, a first number of RX chains are activated.

In some embodiments, the multiple configured component carriers may comprise three component carriers with each one on three individual bands; on the respective bands, the number of MIMO layers is 4; the first number of the activated RX chains is 2, and the first analog filter bandwidth with narrower bandwidth than the second analog filter bandwidth is used for each of the activated RX chains.

In some embodiments, the configuration of the transition between the multiple operational states may comprise a second configuration for the apparatus to transition to or remain in a second operational state, the second configuration comprises the multiple configured component carriers, and in the second operational state, for a first component carrier of the multiple configured component carriers, a number, reduced from the first number, of RX chains is activated for the first component carrier and a number of RX chains beyond the reduced number are deactivated.

In some embodiments, the first component carrier may be on the first band, the multiple configured component carriers may be on the first band and two additional bands; on the respective two component carriers configured on the two additional band, the number of MIMO layers is 4; the first number of the activated RX chains is 2, and the first analog filter bandwidth with narrower bandwidth than the second analog filter bandwidth is used; on the first component carrier of the first band, the number of MIMO layers is 2; the number of the activated RX chains is 1, and the first analog filter bandwidth with narrower bandwidth than the second analog filter bandwidth is used.

In some embodiments, the configuration of the transition between the multiple operational states may comprise a third configuration for the apparatus to transition to or remain in a third operational state, the third configuration comprises a second component carrier on a band besides the band combinations of the three previously used bands, and in the third operational state, the deactivated RX chains are activated for the second component carrier.

In some embodiments, the second component carrier of the multiple configured component carriers may be on a fourth band besides the band combinations of the three previously used bands; on the second component carrier on the fourth band of, the number of MIMO layers is 2; the number of the activated RX chains is 1, and the first analog filter bandwidth with narrower bandwidth than the second analog filter bandwidth is used; on respective two component carriers of the second and third bands, the number of MIMO layers is 4; the first number of the activated RX chains is 2, and the first analog filter bandwidth with narrower bandwidth than the second analog filter bandwidth is used; on the first component carrier of the first band, the number of MIMO layers is 2; the number of the activated RX chains is 1, and the first analog filter bandwidth with narrower bandwidth than the second analog filter bandwidth is used.

In some embodiments, the configuration of the transition between the multiple operational states may comprise a fourth configuration for the apparatus to transition to or remain in a fourth operational state, the fourth configuration comprises a third component carrier on the first band, and in the fourth operational state, the first band having been configured to receive a fourth component carrier is reconfigured for receiving the third component carrier while also receiving the fourth component carrier, and a second analog filter which has wider bandwidth is used on the first band.

In some embodiments, the third component carrier and the fourth component carrier may be both on the first band; on the fourth band, the number of MIMO layers is 2; the number of the activated RX chains is 1, and the first analog filter bandwidth with narrower bandwidth than the second analog filter bandwidth is used; on respective two component carriers of the second and third bands, the number of MIMO layers is 4; the first number of the activated RX chains is 2, and the first analog filter bandwidth with narrower bandwidth than the second analog filter bandwidth is used; on the respective one of the third and the fourth component carriers on the first band, the number of MIMO layers is 2; the number of the activated RX chains is 1, and the second analog filter bandwidth with wider bandwidth than the first analog filter bandwidth is used.

In some embodiments, the first band may be n66, the second band may be n7, the third band may be n25, and/or the fourth band may be n5.

The example embodiments of the present disclosure also provide a computer-readable medium comprising program instructions that, when executed by an apparatus for a terminal device, such as the UE 110 in the above examples, may cause the apparatus at least to: receive a carrier aggregation configuration comprising at least one combination of component carriers; and in response to receiving the carrier aggregation configuration, determine an operational state for receiving a configured combination of component carriers from the at least one combination of component carriers, wherein the operational state is used to determine at least one of: a number of activated RX antennas or a number of RX chains.

In some embodiments, the operational state may be a combination of at least one of: a number of multi-input multi-output, MIMO, layers, a number of RX chains, and analog filter bandwidth.

In some embodiments, the number of MIMO layers may be more than one; the number of RX chains may comprise at least one of: 1 RX chain, 2 RX chains per MIMO layer; and the analog filter bandwidth may comprise: either a first analog filter bandwidth, or a second analog filter bandwidth, and the first analog bandwidth is narrower than the second analog bandwidth.

In some embodiments, the number of the RX chains for a same carrier may be determined based on a receive condition at the apparatus, wherein poorer receive condition demands larger number of RX chains, and better receive condition relaxes the number of RX chains.

In some embodiments, the computer-readable medium may include instructions that, when executed by the apparatus, may cause the apparatus to: deactivate at least one RX chain of the same carrier when the receive condition is above a threshold, and the deactivated at least one RX chain is used as spare RX chain.

In some embodiments, the at least one spare RX chain may be used for at least one of: increasing inter-band combinations or increasing fragments in fragmented carrier aggregation band of the band combinations.

In some embodiments, the computer-readable medium may include instructions that, when executed by the apparatus, may cause the apparatus to: determine to use the combination of component carriers configured from a network.

In some embodiments, the computer-readable medium may include instructions that, when executed by the apparatus, may cause the apparatus to: support multiple operational states of a same activation of hardware to support different levels of carrier aggregation based on at least one of the following conditions: presence of in-gap interference, inter-band combination demand, a number of connectable receive antennas, or an actual MIMO rank.

In some embodiments, the computer-readable medium may include instructions that, when executed by the apparatus, may cause the apparatus to: determine the operational state by selecting antennas based on receiving quality of the antennas with respect to the configured combination of component carriers.

In some embodiments, the computer-readable medium may include instructions that, when executed by the apparatus, may cause the apparatus to: use a second number, reduced from a first number, of active antennas for respective non-contiguous intra-band component carriers, where an active antenna of the second number of active antennas is used for one component carrier; and deactivate a third number of antennas, within the first number of antennas, beyond the second number of antennas.

In some embodiments, the computer-readable medium may include instructions that, when executed by the apparatus, may cause the apparatus to: use a second number, reduced from a first number, of active receive chains at respective antennas for non-contiguous intra-band component carriers, where one active receive chain at the respective antennas is used for the component carriers utilizing a wider analogue filter on the band; and deactivate a third number of receive chains at the respective antennas, within the first number of receive chains at the respective antennas, beyond the second number.

In some embodiments, the computer-readable medium may include instructions that, when executed by the apparatus, may cause the apparatus to: use a first number of active antennas for component carriers on bands comprising at least a first band and a second band, where an active antenna of the first number of active antennas is used for the component carriers on the first band and the second band utilizing wider analogue filters on the first band and the second band.

In some embodiments, the computer-readable medium may include instructions that, when executed by the apparatus, may cause the apparatus to: use a first number of active antennas for component carriers on bands comprising at least a first band and a second band, where an active antenna of a second number, reduced from the first number, of active antennas is used for the component carriers on the first band utilizing a wider analogue filter on the first band, and an active antenna of a third number, reduced from the first number, of active antennas is used for the component carriers on the second band utilizing a wider analogue filter on the second band.

In some embodiments, the computer-readable medium may include instructions that, when executed by the apparatus, may cause the apparatus to: use a fourth number of antennas, within the first number of antennas for the component carriers on the third band where an active antenna of the fourth number of active antennas is used for the component carriers on the third band utilizing a wider analogue filter on the third band.

In some embodiments, the computer-readable medium may include instructions that, when executed by the apparatus, may cause the apparatus to: map the antennas to the component carriers based on receiving performance.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but is not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an JAB node (e.g., a relay node). In the above description, the terms “terminal device”, “communication device”, “terminal”, “user equipment” and “UE” may be used interchangeably.

The term “circuitry” throughout this disclosure may refer to one or more or all of the following: (a) hardware-only circuit implementations (such as implementations in only analog and/or digital circuitry); (b) combinations of hardware circuits and software, such as (as applicable) (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to one or all uses of this term in this disclosure, including in any claims. As a further example, as used in this disclosure, the term circuitry also covers an implementation of merely a hardware circuit or processor (or multiple processors) or portion of a hardware circuit or processor and its (or their) accompanying software and/or firmware. The term circuitry also covers, for example and if applicable to the claim element, a baseband integrated circuit or processor integrated circuit for a mobile device or a similar integrated circuit in server, a cellular network device, or other computing or network device.

Another example embodiment may relate to computer program codes or instructions which may cause an apparatus to perform at least the respective methods described above. Another example embodiment may be related to a computer-readable medium having such computer program codes or instructions stored thereon. In some embodiments, such a computer-readable medium may include at least one storage medium in various forms such as a volatile memory and/or a non-volatile memory. The volatile memory may include, but is not limited to, for example, a RAM, a cache, and so on. The non-volatile memory may include, but is not limited to, a ROM, a hard disk, a flash memory, and so on. The non-volatile memory may also include, but is not limited to, an electric, a magnetic, an optical, an electromagnetic, an infrared, or a semiconductor system, apparatus, or device or any combination of the above.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but is not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

As used herein, the term “determine/determining” (and grammatical variants thereof) can include, not least: calculating, computing, processing, deriving, measuring, investigating, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

While some embodiments have been described, these embodiments have been presented by way of example, and are not intended to limit the scope of the disclosure. Indeed, the apparatus, methods, and systems described herein may be embodied in a variety of other forms; furthermore, various omissions, substitutions, and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. At least one of these blocks may be implemented in a variety of different ways. The order of these blocks may also be changed. Any suitable combination of the elements and actions of the some embodiments described above can be combined to provide further embodiments. The accompanying claims and their equivalents are intended to cover such forms or modifications as would fall within the scope and spirit of the disclosure.

Abbreviations used in the description and/or in the figures are defined as follows:
3GPP 3rd Generation Partnership Project
5G fifth generation of mobile communication system
BS base station
CA carrier aggregation
CC component carrier
DL downlink
gNB next Generation Node B
LB low bass
LO local oscillator
MAC medium access control
MAC CE MAC control element
MIMO multi-input multi-output
NC IB CA non-contiguous intra-band carrier aggregation
PCC primary carrier component
RF radio frequency
RI rank indicator
RRC radio resource control
RRM radio resource management
RX receive
SCC secondary carrier component
UE user equipment

1. An apparatus for a terminal device, comprising:
at least one processor; and
at least one memory storing instructions that, when executed with the at least one processor, cause the apparatus at least to:
receive a carrier aggregation configuration comprising at least one combination of component carriers; and
in response to receiving the carrier aggregation configuration, determine an operational state for receiving a configured combination of component carriers from the at least one combination of component carriers, wherein the operational state is used to determine at least one of: a number of activated receiving antennas or a number of receiving chains.

2. The apparatus of claim 1, wherein the operational state is a combination of at least one of: a number of multi-input multi-output layers, a number of receiving chains, or analog filter bandwidth.

3. The apparatus of claim 2, wherein
the number of multi-input multi-output layers is more than one;
the number of receiving chains comprises at least one of: one receiving chain or two receiving chains per multi-input multi-output layer; and
the analog filter bandwidth comprises: either a first analog filter bandwidth or a second analog filter bandwidth, and the first analog bandwidth is narrower than the second analog bandwidth.

4. The apparatus of claim 1, wherein the number of the receiving chains for a same carrier is determined based on a receive condition at the apparatus, wherein poorer receive condition demands a larger number of receiving chains, and better receive condition relaxes the number of receiving chains.

5. The apparatus of claim 1, wherein the instructions, when executed with the at least one processor, cause the apparatus to:
deactivate at least one receiving chain of the same carrier when the receive condition is above a threshold, and the deactivated at least one receiving chain is used as spare receiving chain.

6. The apparatus of claim 5, wherein the at least one spare receiving chain is used for at least one of: increasing inter-band combinations or increasing fragments in fragmented carrier aggregation band of the band combinations.

7. The apparatus of claim 1, wherein the instructions, when executed with the at least one processor, cause the apparatus to:
determine to use the combination of component carriers configured from a network.

8. The apparatus of claim 1, wherein the instructions, when executed with the at least one processor, cause the apparatus to:
support multiple operational states of a same activation of hardware to support different levels of carrier aggregation based on at least one of the following conditions: presence of in-gap interference, inter-band combination demand, a number of connectable receive antennas, or an actual multi-input multi-output rank.

9. The apparatus of claim 1, wherein the instructions, when executed with the at least one processor, cause the apparatus to:
determine the operational state with selecting antennas based on receiving quality of the antennas with respect to the configured combination of component carriers.

10. The apparatus of claim 1, wherein the instructions, when executed with the at least one processor, cause the apparatus to:
use a second number, reduced from a first number, of active antennas for respective non-contiguous intra-band component carriers, where an active antenna of the second number of active antennas is used for one component carrier; and
deactivate a third number of antennas, within the first number of antennas, beyond the second number of antennas.

11. The apparatus of claim 1, wherein the instructions, when executed with the at least one processor, cause the apparatus to:
use a second number, reduced from a first number, of active receive chains at respective antennas for non-contiguous intra-band component carriers, where one active receive chain at the respective antennas is used for the component carriers utilizing a wider analogue filter on the band; and
deactivate a third number of receive chains at the respective antennas, within the first number of receive chains at the respective antennas, beyond the second number.

12. The apparatus of claim 1, wherein the instructions, when executed with the at least one processor, cause the apparatus to:
use a first number of active antennas for component carriers on bands comprising at least a first band and a second band, where an active antenna of the first number of active antennas is used for the component carriers on the first band and the second band utilizing wider analogue filters on the first band and the second band.

13. The apparatus of claim 1, wherein the instructions, when executed with the at least one processor, cause the apparatus to:
use a first number of active antennas for component carriers on bands comprising at least a first band and a second band, where an active antenna of a second number, reduced from the first number, of active antennas is used for the component carriers on the first band utilizing a wider analogue filter on the first band, and an active antenna of a third number, reduced from the first number, of active antennas is used for the component carriers on the second band utilizing a wider analogue filter on the second band.

14. The apparatus of claim 13, wherein the component carriers comprise component carriers on a third band, and the instructions, when executed with the at least one processor, cause the apparatus to:
use a fourth number of antennas, within the first number of antennas for the component carriers on the third band where an active antenna of the fourth number of active antennas is used for the component carriers on the third band utilizing a wider analogue filter on the third band.

15. The apparatus of claim 8, wherein the instructions, when executed with the at least one processor, cause the apparatus to:
map the antennas to the component carriers based on receiving performance.

16. A method performed with an apparatus for a terminal device, comprising:
receiving a carrier aggregation configuration comprising at least one combination of component carriers; and
in response to receiving the carrier aggregation configuration, determining an operational state for receiving a configured combination of component carriers from the at least one combination of component carriers, wherein the operational state is used to determine at least one of: a number of activated receiving antennas or a number of receiving chains.

17. (canceled)

18. A computer-readable medium comprising program instructions that, when executed by an apparatus for a terminal device, cause the apparatus to at least:
receive a carrier aggregation configuration comprising at least one combination of component carriers; and
in response to receiving the carrier aggregation configuration, determine an operational state for receiving a configured combination of component carriers from the at least one combination of component carriers, wherein the operational state is used to determine at least one of: a number of activated receiving antennas or a number of receiving chains.
